(19) United States
(12) Patent Application Publication
(10) Pub. No.: US 2025/0234361 A1
(43) Pub. Date: Jul. 17, 2025

(54) USER DEVICE SUPPORT BY A BASE STATION FOR A SIDELINK COMMUNICATION IN AN UNLICENSED SPECTRUM

(71) Applicant: FRAUNHOFER-GESELLSCHAFT ZUR FOERDERUNG DER ANGEWANDTEN FORSCHUNG E.V., Muenchen (DE)

(72) Inventors: Thomas WIRTH, Berlin (DE); Sarun SELVANESAN, Berlin (DE)

(21) Appl. No.: 19/024,503

(22) Filed: Jan. 16, 2025

Related U.S. Application Data
(63) Continuation of application No. PCT/EP2023/070617, filed on Jul. 25, 2023.

(30) Foreign Application Priority Data
Jul. 28, 2022 (EP) 22187438.1

(51) Int. Cl. H04W 72/25; H04B 17/318; H04W 74/00

(52) U.S. Cl. CPC H04W 72/25; H04B 17/328; H04W 74/002

(57) ABSTRACT

A network entity for a wireless communication network, like a 3^{rd} Generation Partnership Project, 3GPP, network, is described. The network entity is to serve a plurality of user devices, which are to communicate with each other over a sidelink, SL, using resources from an unlicensed SL resource pool, SL-U RP, the SL-U RP including a plurality of resources from an unlicensed spectrum to be used for SL transmissions. For performing a SL transmission on the resources in the unlicensed spectrum by a UE, the network entity is to provide a grant to the UE.

### CROSS-REFERENCE TO RELATED APPLICATIONS

This application is a continuation of copending International Application No. PCT/EP2023/070617, filed Jul. 25, 2023, which is incorporated herein by reference in its entirety, and additionally claims priority from European Application No. 22187438.1, filed Jul. 28, 2022, which is also incorporated herein by reference in its entirety.

### TECHNICAL FIELD

The present invention concerns the field of wireless communication systems or networks, more specifically, a direct communication between user devices over a sidelink using resources in the unlicensed spectrum. Embodiments concern the support of a user device, UE, operating in Mode 1 by a base station with regard to a channel access procedure to be used when performing a sidelink communication in the unlicensed spectrum.

### BACKGROUND OF THE INVENTION

FIGS. 1A and B are a schematic representation of an example of a terrestrial wireless network 100 including, as is shown in FIG. 1A, the core network 102 and one or more radio access networks RAN₁, RAN₂, . . . . RAN_{N}. FIG. 1B is a schematic representation of an example of a radio access network RANₙ that may include one or more base stations gNB₁ to gNB₅, each serving a specific area surrounding the base station schematically represented by respective cells 106₁ to 106₅. The base stations are provided to serve users within a cell. The one or more base stations may serve users in licensed and/or unlicensed bands. The term base station, BS, refers to a gNB in 5G networks, an eNB in UMTS/LTE/LTE-A/LTE-A Pro, or just a BS in other mobile communication standards. A user may be a stationary device or a mobile device. The wireless communication system may also be accessed by mobile or stationary IoT devices which connect to a base station or to a user. The mobile or stationary devices may include physical devices, ground based vehicles, such as robots or cars, aerial vehicles, such as manned or unmanned aerial vehicles, UAVs, the latter also referred to as drones, buildings and other items or devices having embedded therein electronics, software, sensors, actuators, or the like as well as network connectivity that enables these devices to collect and exchange data across an existing network infrastructure. FIG. 1B shows an exemplary view of five cells, however, the RANₙ may include more or less such cells, and RANₙ may also include only one base station. FIG. 1B shows two users UE₁ and UE₂, also referred to as user device or user equipment, that are in cell 106₂ and that are served by base station gNB₂. Another user UE₃ is shown in cell 106₄ which is served by base station gNB₄. The arrows 108₁, 108₂ and 108₃ schematically represent uplink/downlink connections for transmitting data from a user UE₁, UE₂ and UE₃ to the base stations gNB₂, gNB₄ or for transmitting data from the base stations gNB₂, gNB₄ to the users UE₁, UE₂, UE₃. This may be realized on licensed bands or on unlicensed bands. Further, FIG. 1B shows two further devices 110₁ and 110₂ in cell 106₄, like IoT devices, which may be stationary or mobile devices. The device 110₁ accesses the wireless communication system via the base station gNB₄ to receive and transmit data as schematically represented by arrow 112₁. The device 110₂ accesses the wireless communication system via the user UEs as is schematically represented by arrow 112₂. The respective base station gNB₁ to gNB₅ may be connected to the core network 102, e.g., via the S1 interface, via respective backhaul links 114₁ to 114₅, which are schematically represented in FIG. 1B by the arrows pointing to “core”. The core network 102 may be connected to one or more external networks. The external network may be the Internet, or a private network, such as an Intranet or any other type of campus networks, e.g., a private WiFi communication system or a 4G or 5G mobile communication system. Further, some or all of the respective base station gNB₁ to gNB₅ may be connected, e.g., via the S1 or X2 interface or the XN interface in NR, with each other via respective backhaul links 116₁ to 116₅, which are schematically represented in FIG. 1B by the arrows pointing to “gNBs”. A sidelink channel allows direct communication between UEs, also referred to as device-to-device, D2D, communication. The sidelink interface in 3GPP is named PC5.

For data transmission a physical resource grid may be used. The physical resource grid may comprise a set of resource elements to which various physical channels and physical signals are mapped. For example, the physical channels may include the physical downlink, uplink and sidelink shared channels, PDSCH, PUSCH, PSSCH, carrying user specific data, also referred to as downlink, uplink and sidelink payload data, the physical broadcast channel, PBCH, and the physical sidelink broadcast channel, PSBCH, carrying for example a master information block, MIB, and one or more system information blocks, SIBs, one or more sidelink information blocks, SLIBs, if supported, the physical downlink, uplink and sidelink control channels, PDCCH, PUCCH, PSSCH, carrying for example the downlink control information, DCI, the uplink control information, UCI, and the sidelink control information, SCI, and physical sidelink feedback channels, PSFCH, carrying PC5 feedback responses. The sidelink interface may support a 2-stage SCI which refers to a first control region containing some parts of the SCI, also referred to as the 1^{st}-stage SCI, and optionally, a second control region which contains a second part of control information, also referred to as the 2^{nd}-stage SCI.

For the uplink, the physical channels may further include the physical random-access channel, PRACH or RACH, used by UEs for accessing the network once a UE synchronized and obtained the MIB and SIB. The physical signals may comprise reference signals or symbols, RS, synchronization signals and the like. The resource grid may comprise a frame or radio frame having a certain duration in the time domain and having a given bandwidth in the frequency domain. The frame may have a certain number of subframes of a predefined length, e.g., 1 ms. Each subframe may include one or more slots of 12 or 14 OFDM symbols depending on the cyclic prefix, CP, length. A frame may also have a smaller number of OFDM symbols, e.g., when utilizing shortened transmission time intervals, sTTI, or a mini-slot/non-slot-based frame structure comprising just a few OFDM symbols.

The wireless communication system may be any single-tone or multicarrier system using frequency-division multiplexing, like the orthogonal frequency-division multiplexing, OFDM, system, the orthogonal frequency-division multiple access, OFDMA, system, or any other Inverse Fast Fourier Transform, IFFT, based signal with or without Cyclic Prefix, CP, e.g., Discrete Fourier Transform-spread-OFDM, DFT-s-OFDM. Other waveforms, like non-orthogonal waveforms for multiple access, e.g., filter-bank multicarrier, FBMC, generalized frequency division multiplexing, GFDM, or universal filtered multi carrier, UFMC, may be used. The wireless communication system may operate, e.g., in accordance with 3GPPs LTE, LTE-Advanced, LTE-Advanced Pro, or the 5G or 3GPPs NR, New Radio,, or within NR-U, New Radio Unlicensed, which is specified within the LTE and within NR specifications.

The wireless network or communication system depicted in FIGS. 1A and B may be a heterogeneous network having distinct overlaid networks, e.g., a network of macro cells with each macro cell including a macro base station, like base station gNB₁ to gNB₅, and a network of small cell base stations, not shown in FIGS. 1A and B, like femto or pico base stations. In addition to the above-described terrestrial wireless network also non-terrestrial wireless communication networks, NTN, exist including spaceborne transceivers, like satellites, and/or airborne transceivers, like unmanned aircraft systems. The non-terrestrial wireless communication network or system may operate in a similar way as the terrestrial system described above with reference to FIGS. 1A and B, for example in accordance with the LTE-Advanced Pro or 5G or NR, New Radio.

In mobile communication networks, for example in a network like that described above with reference to FIGS. 1A and B, like a LTE or 5G/NR network, there may be UEs that communicate directly with each other over one or more sidelink, SL, channels, e.g., using the PC5/PC3 interface or WiFi direct. UEs that communicate directly with each other over the sidelink may include vehicles communicating directly with other vehicles, V2V communication, vehicles communicating with other entities of the wireless communication network, V2X communication, for example roadside units, RSUs, roadside entities, like traffic lights, traffic signs, or pedestrians. An RSU may have a functionality of a BS or of a UE, depending on the specific network configuration. Other UEs may not be vehicular related UEs and may comprise any of the above-mentioned devices. Such devices may also communicate directly with each other, D2D communication, using the SL channels.

When considering two UEs directly communicating with each other over the sidelink, both UEs may be served by the same base station so that the base station may provide sidelink resource allocation configuration or assistance for the UEs. For example, both UEs may be within the coverage area of a base station, like one of the base stations depicted in FIGS. 1A and B. This is referred to as an “in-coverage” scenario. Another scenario is referred to as an “out-of-coverage” scenario. It is noted that “out-of-coverage” does not mean that the two UEs are necessarily outside one of the cells depicted in FIGS. 1A and B, rather, it means that these UEs
may not be connected to a base station, for example, they are not in an RRC connected state, so that the UEs do not receive from the base station any sidelink resource allocation configuration or assistance, and/or
may be connected to the base station, but, for one or more reasons, the base station may not provide sidelink resource allocation configuration or assistance for the UEs, and/or
may be connected to the base station that may not support NR V2X services, e.g., GSM, UMTS, LTE base stations.

FIG. 2A is a schematic representation of an in-coverage scenario in which two UEs directly communicating with each other are both connected to a base station. The base station gNB has a coverage area that is schematically represented by the circle 200 which, basically, corresponds to the cell schematically represented in FIGS. 1A and B. The UEs directly communicating with each other include a first vehicle 202 and a second vehicle 204 both in the coverage area 200 of the base station gNB. Both vehicles 202, 204 are connected to the base station gNB and, in addition, they are connected directly with each other over the PC5 interface. The scheduling and/or interference management of the V2V traffic is assisted by the gNB via control signaling over the Uu interface, which is the radio interface between the base station and the UEs. In other words, the gNB provides SL resource allocation configuration or assistance for the UEs, and the gNB assigns the resources to be used for the V2V communication over the sidelink. This configuration is also referred to as a mode 1 configuration in NR V2X or as a mode 3 configuration in LTE V2X. Thus, in Mode 1, a SL UE, e.g., UE 202 is connected via Uu interface to the gNB, and the gNB coordinates the resources for UE 202 be used to transmit control and/or data to another UE, e.g., UE 204, via a SL interface, which is referred to in NR as PC5.

FIG. 2B is a schematic representation of an out-of-coverage scenario in which the UEs directly communicating with each other are either not connected to a base station, although they may be physically within a cell of a wireless communication network, or some or all of the UEs directly communicating with each other are connected to a base station but the base station does not provide for the SL resource allocation configuration or assistance. Three vehicles 206, 208 and 210 are shown directly communicating with each other over a sidelink, e.g., using the PC5 interface. The scheduling and/or interference management of the V2V traffic is based on algorithms implemented between the vehicles. This configuration is also referred to as a mode 2 configuration in NR V2X or as a mode 4 configuration in LTE V2X. As mentioned above, the scenario in FIG. 2B which is the out-of-coverage scenario does not necessarily mean that the respective mode 2 UEs in NR or mode 4 UEs in LTE are outside of the coverage 200 of a base station, rather, it means that the respective mode 2 UEs in NR or mode 4 UEs in LTE are not served by a base station, are not connected to the base station of the coverage area, or are connected to the base station but receive no SL resource allocation configuration or assistance from the base station. Thus, there may be situations in which, within the coverage area 200 shown in FIG. 2A, in addition to the NR mode 1 or LTE mode 3 UEs 202, 204 also NR mode 2 or LTE mode 4 UEs 206, 208, 210 are present. In addition, FIG. 2B, schematically illustrates an out of coverage UE using a relay to communicate with the network. For example, the UE 210 may communicate over the sidelink with UE 212 which, in turn, may be connected to the gNB via the Uu interface. Thus, UE 212 may relay information between the gNB and the UE 210.

Thus, the SL UEs, e.g., UEs 206-210, need not to have a connectivity to the gNB, and perform a sensing & access resource allocation or a random access-based resource allocation, e.g., when transmitting from UE 206 to UE 208. Nevertheless, basic configurations need to be available for the UEs 206-210, in order to successfully exchange data. This information may be pre-configured or may be configured while a UE is within coverage of the gNB. For this the gNB may provide a basic configuration, e.g., basic information, which may be transported via a broadcast channel, e.g., using system information blocks (SIBs). The BS may also assist Mode 2 UEs to provide basic information on which resource pool (RP) is to be used or may act as a synchronization source.

Although FIG. 2A and FIG. 2B illustrate vehicular UEs, it is noted that the described in-coverage and out-of-coverage scenarios also apply for non-vehicular UEs. In other words, any UE, like a hand-held device, communicating directly with another UE using SL channels may be in-coverage and out-of-coverage.

In the above-described scenarios of vehicular user devices, UEs, a plurality of such user devices may form a user device group, also referred to simply as group, and the communication within the group or among the group members may be performed via the sidelink interfaces between the user devices, like the PC5 interface. For example, the above-described scenarios using vehicular user devices may be employed in the field of the transport industry in which a plurality of vehicles being equipped with vehicular user devices may be grouped together, for example, by a remote driving application. Other use cases in which a plurality of user devices may be grouped together for a sidelink communication among each other include, for example, factory automation and electrical power distribution. In the case of factory automation, a plurality of mobile or stationary machines within a factory may be equipped with user devices and grouped together for a sidelink communication, for example for controlling the operation of the machine, like a motion control of a robot. In the case of electrical power distribution, entities within the power distribution grid may be equipped with respective user devices which, within a certain area of the system may be grouped together so as to communicate via a sidelink communication with each other so as to allow for monitoring the system and for dealing with power distribution grid failures and outages.

It is noted that the information in the above section is only for enhancing the understanding of the background of the invention and, therefore, it may contain information that does not form conventional technology that is already known to a person of ordinary skill in the art.

### SUMMARY

An embodiment may have a network entity for a wireless communication network, like a 3^{rd} Generation Partnership Project, 3GPP, network, wherein the network entity is to serve a plurality of user devices, which are to communicate with each other over a sidelink, SL, using resources from an unlicensed SL resource pool, SL-U RP, the SL-U RP including a plurality of resources from an unlicensed spectrum to be used for SL transmissions, wherein, for performing a SL transmission on the resources in the unlicensed spectrum by a UE, the network entity is to provide a grant to the UE.

Another embodiment may have a user device, UE, for a wireless communication network, like a 3^{rd} Generation Partnership Project, 3GPP, network, wherein the UE is served by a network entity and is to communicate with other UEs over a sidelink, SL, using resources from an unlicensed SL resource pool, SL-U RP, the SL-U RP including a plurality of resources from an unlicensed spectrum to be used for SL transmissions, wherein, for performing a SL transmission on the resources in the unlicensed spectrum, the UE is to receive from the network entity a grant, the grant indicating the resources from the SL-U RP to be used by the UE for performing the SL transmission in the unlicensed spectrum.

According to still another embodiment, a method for operating a user device, UE, for a wireless communication network, like a 3^{rd} Generation Partnership Project, 3GPP, network, wherein the UE is served by a network entity and is to communicate with other UEs over a sidelink, SL, using resources from an unlicensed SL resource pool, SL-U RP, the SL-U RP including a plurality of resources from an unlicensed spectrum to be used for SL transmissions, may have the step of: receiving from the network entity a grant for performing a SL transmission on the resources in the unlicensed spectrum, the grant indicating the resources from the SL-U RP to be used by the UE for performing the SL transmission in the unlicensed spectrum.

### BRIEF DESCRIPTION OF THE DRAWINGS

Embodiments of the present invention are now described in further detail with reference to the accompanying drawings, in which:

FIGS. 1A and B are a schematic representation of an example of a terrestrial wireless network;

FIG. 2A is a schematic representation of an in-coverage scenario;

FIG. 2B is a schematic representation of an out-of-coverage scenario;

FIG. 3 is a schematic representation of a wireless communication system including a transmitter, like a base station, and one or more receivers, like user devices, UEs, implementing embodiments of the present invention;

FIG. 4 illustrates a wireless communication system including a base station in accordance with embodiments of a first aspect of the present invention;

FIG. 5 illustrates a sidelink resource pool in accordance with embodiments of the first aspect of the present invention;

FIG. 6 illustrates a sidelink resource pool in accordance with further embodiments of the first aspect of the present invention;

FIG. 7 illustrates a wireless communication system including user devices and a base station in accordance with embodiments of a second aspect of the present invention; and

FIG. 8 illustrates a request-based resource configuration performed by a base station in accordance with embodiments of the second aspect of the present invention;

FIG. 9 illustrates a feedback-based resource configuration performed by a base station in accordance with embodiments of the second aspect of the present invention;

FIG. 10 illustrates a BSR-Config IE to be modified in accordance with embodiments of the present invention;

FIG. 11 illustrates a SL-ConfiguredGrantConfig IE to be modified in accordance with embodiments of the present invention; and

FIG. 12 illustrates an example of a computer system on which units or modules as well as the steps of the methods described in accordance with the inventive approach may execute.

### DETAILED DESCRIPTION OF THE INVENTION

Embodiments of the present invention are now described in more detail with reference to the accompanying drawings, in which the same or similar elements have the same reference signs assigned.

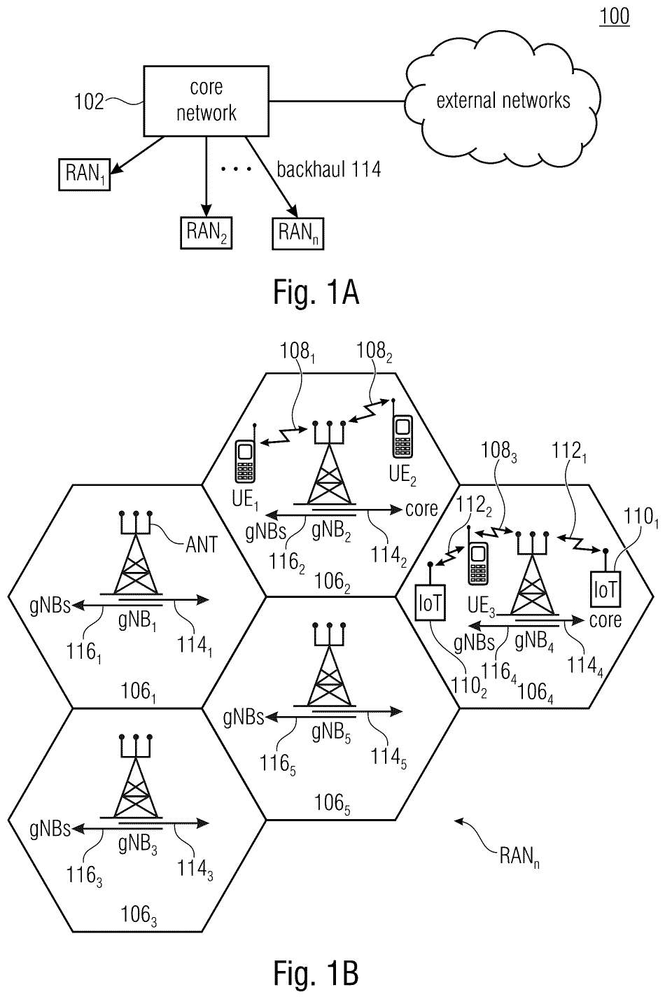

In mobile communication systems or networks, like those described above with reference to FIGS. 1A and B, for example in an LTE or 5G/NR network, the respective entities may communicate using one or more frequency bands. A frequency band includes a start frequency, an end frequency and all intermediate frequencies between the start and end frequencies. In other words, the start, end and intermediate frequencies may define a certain bandwidth, e.g., 20 MHz. A frequency band may also be referred to as a carrier or subcarrier, a bandwidth part, BWP, a subband, a subchannel, and the like.

When using a single frequency band, the communication may be referred to as a single-band operation, e.g., a UE transmits/receives radio signals to/from another network entity on frequencies being within the band, like the 20 MHz band.

When using a two or more frequency bands, the communication may be referred to as a multi-band operation or as a wideband operation or as a carrier aggregation operation. The frequency bands may have different bandwidths or the same bandwidth, like 20 MHz. For example, in case of frequency bands having the same bandwidths a UE may transmit/receive radio signals to/from another network entity on frequencies being within two or more of the 20 MHz bands so that the frequency range for the radio communication may be a multiple of 20 MHz. The two or more frequency bands may be continuous/adjacent frequency bands or some or all for the frequency bands may be separated in the frequency domain.

The multi-band operation may include frequency bands in the licensed spectrum, or frequency bands in the unlicensed spectrum, or frequency bands both in the licensed spectrum and in the unlicensed spectrum.

Carrier aggregation, CA, is an example using two or more frequency bands in the licensed spectrum and/or in the unlicensed spectrum. Also mixed combinations are possible, e.g., one or more frequency bands in licensed and one or more frequency bands in unlicensed bands. Furthermore, CA may also be just used for aggregation of an additional carrier in one direction, e.g., as a supplemental carrier to improve transmissions via UL, DL or SL.

5G New Radio (NR) may support an operation in the unlicensed spectrum so that a single-band operation or a multi-band operation may include frequency bands or subbands in the unlicensed spectrum. The unlicensed spectrum may include bands with a potential IEEE 802.11 coexistence, such as frequency bands within the 5 GHz and/or the 6 GHz spectrum. NR-U may support bandwidths that are an integer multiple of 20 MHz, for example due to regulatory requirements. The splitting into the subbands may be performed so as to minimize interference with coexisting systems, like IEE 802.11 systems, which may operate in one or more of the same bands with the same nominal bandwidth channels, like 20 MHz channels. Other examples, of coexisting systems may use subbands having subband sizes and nominal frequencies different from the above-described IEEE 802.11 systems. For example, the unlicensed spectrum may include the 5 GHz band, the 6 GHz band, the 24 GHz band or the 60 GHz band. Examples of such unlicensed bands include the industrial, scientific and medical, ISM, radio bands reserved internationally for the use of radio frequency energy for industrial, scientific and medical purposes other than telecommunications.

During an operation using unlicensed subbands, Listen-before-talk, LBT, may be performed separately per subband. This may lead to a situation in which one or more of the subbands are busy or occupied due to an interference, for example, from other communication systems coexisting on the same band, like other public land mobile networks, PLMNs or systems operating in accordance with the IEEE 802.11 specification or operating under the ETSI Broadband Radio Access Networks, BRAN, specifications. In such a situation, the transmitter, either the transmitting gNB or the transmitting UE, is only allowed to transmit on the subbands which are detected to be not busy, also referred to as subbands being free or non-occupied. For example, for a transmission spanning more than 20 MHz in the 5 GHz operational unlicensed band, the transmitter, like the gNB or the UE, performs Listen-Before-Talk, LBT, separately on each subband. Once the LBT results are available for each subband, the devices, for example, the gNB in the downlink, DL, or the UE in the uplink, UL, are allowed to transmit on those subbands which are determined to be free or unoccupied, i.e., to transmit on the won subband(s). No transmission is allowed on the occupied, busy, or non-won subbands.

For accessing resources or channels in the unlicensed spectrum, a so-called NR-U channel access is to be performed, which makes use of a channel access procedure, which is a procedure based on sensing that evaluates the availability of a channel for performing transmissions. The basic unit for sensing may be a sensing slot with a certain duration, e.g., Tₛᵢ=9 μs. The sensing slot duration Tₛᵢ is considered to be idle if a base station or a UE senses the channel during the sensing slot duration and determines that the detected power is less than an energy detection threshold for at least a certain time, like 4 μs. within the sensing slot duration. Otherwise, the sensing slot duration is considered to be busy. In case a channel is available or not busy, one or more transmission may be performed on the channel, and the so-called channel occupancy refers to the one or more transmissions on the one or more channels by the base station or UE after performing the corresponding channel access procedure. A channel occupancy time refers to the total time for which the base station or UE and any other base station or UE may share the channel occupancy to perform one or more transmissions on the channel after the base station or UE has performed the channel access procedure. For determining a channel occupancy time, if a transmission gap is less than or equal to a certain period, like 25 μs, the gap duration is counted in the channel occupancy time. A channel occupancy time may be shared for a transmission between a base station and a corresponding UE.

Several types of channel access procedures, CAPs, may exist, e.g.:
Type-1 CAP The time duration for which the sensed channel has be idle before the transmission may be random. For example, a base station or a UE may determine an initial counter N which is randomly selected to be between 0 and CWₚ, where CW_{min,p}≤CWₚ≤CW_{max,p}, with CW_{min,p} and CW_{max,p} being subject to the channel access procedure class, CAPC. When the channel is sensed to be idle for a certain period of time, the value of N is decreased, and a transmission may take place only once N reaches 0.
Type-2A: The time duration for which the sensed channel has be idle before the transmission may be deterministic, and the channel may need to be idle for a sensing interval of a first duration, like 25 μs.
Type-2B: The time duration for which the sensed channel has be idle before the transmission may be deterministic, and the channel may need to be idle for a sensing interval of a second duration shorter than the first duration, like 16 μs.
Type-2C: This type does not perform any sensing of the channel before the transmission, and the duration of a corresponding transmission may have a predefined duration, e.g., may be at most 583 μs.

For downlink, DL, multiple-channel accesses, respective types of DL multi-channel access procedures may exist, e.g.:
Type-A: This type requires the base station to perform a Type 1 LBT on each channel.
Type-B: This type requires the base station to perform a Type 1 LBT on one of the multiple channels and sense the other channels for at least a sensing interval of a certain duration, like 25 μs, before performing a transmission, optionally with the constraint that a selection of channels may be random or a selection of the channel may not be more frequent than once every 1 second.

For uplink, UL, multi-channel access procedures, a UE is either scheduled to start a transmission on channels as indicated by the base station or is to perform an uplink transmission on configured resources. The UE only performs a single-channel sensing or access procedure, for example, of Type 1 or Type 2, on a certain channel as indicated by the base station.

As mentioned above, for a sidelink communication, like a communication between a vehicle and another entity of a wireless communication network, e.g., NR V2X, the operation may be in the above-described Mode 1 in which the resource allocation is carried out by the gNB. The use cases intended, for example, for NR V2X require to generate a diverse array of periodic and aperiodic message types and, therefore, the resource allocation in Mode 1 provides dynamic grants, DG, of the sidelink resources from the gNB, as well as grants of periodic sidelink resources which are configured semi-statically by RRC, and are referred to as configured grants, CG.

A dynamic sidelink grant, e.g., transmitted via DCI from the gNB to the UE, may provide resources for one or multiple transmissions of a transport block, TB, in order to allow a control of the reliability of the transmission. The transmission may be subject to a sidelink Hybrid Automatic Repeat Request, HARQ, procedure, provided this operation is enabled.

A sidelink configured grant, CG, may be such that it is configured once and may be used by the UE immediately, until it is released by RRC signaling, which is also referred to as a Type 1 CG. A UE is allowed to continue using this type of sidelink CG also when a beam failure or physical layer problems occur in the NR Uu interface until a radio link failure, RLF, detection timer expires. After that, the UE may fall back to an exceptional resource pool. Another type of a sidelink CG, which is referred to as the Type 2 CG, is configured once but may not be used until the gNB sends the UE a DCI indicating that the CG is now active. Further, it may only be used until another DCI indicates a de-activation of the CG. In both types, the resources are a set of sidelink resources recurring with a periodicity which a gNB may desire to match to the characteristics of the V2X traffic. Also, multiple CGs may be configured so as to allow for the provision of different services, traffic types and the like.

Information on the modulation and coding scheme, MCS, to be used for DGs and CGs, may optionally be provided or constrained using RRC signaling, instead of a conventional DCI signaling. RRC may configure the exact MCS the transmitting UE is to use or arrange for available MCSs. The MCS may also be left non-configured so that, for cases where RRC does not provide an exact MCS to be used, the transmitting UE is left to select an appropriate MSC itself, e.g., based on the knowledge it has of the TB to be transmitted and, if available, the sidelink radio conditions.

The gNB scheduling activity is driven by the UE reporting it sidelink traffic characteristics to the gNB or by performing a sidelink buffer status report, BSR, procedure, similar to that on the Uu interface to request a sidelink resource allocation from the gNB. Basically, there are four actions a gNB may perform for supporting a UE operating in Mode 1.

Action 1: The gNB may carry out sensing and channel access procedures, like LBT procedures, without transmitting on the unlicensed resources, and based on the outcome of the procedures the gNB may provide CGs or DGs to the UE via Mode 1 signaling, i.e., via the Uu interface. This means that the UE may use the resources without carrying out any further channel access procedure, like a further LBT, for checking whether the resources are indeed available. Alternatively, depending on 105-106 grant and/or further signaling provided by the gNB, the UE may not completely skip its LTE procedure, but adapt its LBT-procedure for a more optimized channel access. E.g., the listening part of its LBT-procedure may be shortened, such that a UE waiting time is reduced so that the UE may have an overall quicker access to the medium. This may be considered to be similar to how the gNB initiates COT sharing for UEs to transmit in the uplink.

However, in accordance with the NR standards, such an implementation may not be desired, i.e., the gNB may be not expected to perform any Type-1 LBT or Type-2 LBT and, therefore, is not able to report sensing or resource allocation information to the UE.

Action 2: The gNB may perform a high-level resource coordination when providing the GCs or DGs to the UE so as to limit resource collisions and LBT failures. The UE is expected to carry out a channel access procedure, like an LBT, on the resources for the CG or DG.

Action 3: The gNB does not carry out any sensing or channel access procedures but receives reports from one or more other UEs that have carried out such procedures. The gNB incorporates this information, when providing grants, e.g., the CGs or DGs, to the UEs. In such situations, a UE may skip carrying out a CAP, like an LBT, again on the resources indicated in the CG or DG.

Action 4: The gNB does not carry out any sensing and channel access procedure but only provides grants, e.g., the CGs or DGs, to the UE so that the UE is expected to carry out a CAP on the resources indicated in the CG or DG.

Despite the fact that the standardization may not allow the gNB to actively support the UE with regard to the availability of resources in the unlicensed spectrum to be used for a sidelink transmission, i.e., the gNB may not perform the above described Action 1, there is nevertheless a need for improving or enhancing the operation of the sidelink communication in terms of supporting the UE with regard to the availability of resources to be used when performing a sidelink communication in an unlicensed spectrum. The present invention addresses these needs and, more specifically, concerns Action 2 and Action 3 mentioned above in accordance with which the gNB does not carry out any active CAP, like an LBT, as it does, for example, in NR-U, but provides further means to ensure that the gNB may nevertheless assist a UE for its Mode 1 operations with regard to the availability of resources provided for transmissions.

### First Aspect

In accordance with a first aspect, according to Action 2, the gNB is to provide some support to the UE for carrying out transmissions on an unlicensed band without violating the requirement that the gNB is not to perform any Type-1 LBT or Type-2 LBT on the resources to be used for the sidelink communication in the unlicensed band. In accordance with the first aspect, a high-level resource coordination by a base station, like a gNB, is provided, more specifically, the gNB may perform a high-level resource coordination within a resource pool configuration that it provides to the UE. Within this resource pool, the gNB may provide CGs or DGs to the UEs in a way that reduces or minimizes the CAP effort, like an LBT effort, that the UEs have to do, thereby reducing or avoiding CAP failures encountered by a UE. The inventive approach, in accordance with the first aspect, achieves this by providing a network entity, like a base station or another UE, which serves one or more user devices and provides resources for a sidelink transmission from the unlicensed spectrum by providing a grant, like a CG or a DG, to the UE, wherein the network entity is to cluster the UEs it serves into one or more different groups dependent on properties of the UEs themselves and/or dependent on properties of the sidelink transmissions to be performed by the UEs. For each group a subset of the resources of the unlicensed sidelink resource pool, SL-U RP, is available. Thus, when it comes to a request for a grant from a UE for resources to be used for a sidelink transmission in the unlicensed spectrum, the network entity, like the gNB, either has or obtains knowledge about certain properties of the UE and/or of the sidelink transmission to be performed by the UE, and, dependent on these one or more properties, determines the group and selects the resources for the grant from the resources associated with the group to which the UE belongs.

For example, the gNB may have information on a user location and may thus coordinate resources in such a way that the probability of collisions due to over-utilization of the spectrum is reduced. In such an embodiment, the gNB may assign UEs in direct communication located in a same area, e.g., within the same zone, or within a minimum required communication range, to one set of resources, and other UEs, e.g., other pairs of UEs communicating within the same zone to another set of resources. In this way, the interference between these two groups is reduced, which leads to less LBT failures.

It is noted that the user location itself may come from the UEs, e.g., may be provided as GPS coordinates, or as a zone ID. Alternatively, the gNB may estimate this itself, e.g., by evaluating received signals or by analyzing the receive beamformer, the gNB may also query 5G core network functions, e.g., the Location Management Function, LMF, which may have this information available. Note that GPS coordinates may be in 2D or 3D, e.g., and may thus involve a height of a UE, e.g., in case the UE is a drone or unmanned aerial vehicle, UAV.

Furthermore, if the gNB is aware of any other communication going on in the unlicensed spectrum, e.g., by sensing data from a nearby non-3GPP RAT, e.g., a WiFi access point, it may coordinate the spectrum for SL-U UEs such that CGs or DGs are given in a different part of the unlicensed spectrum which is not interfered by this non-3GPP RAT. This may also reduce an interference and thus LBT-failures at the SL-U UEs.

Furthermore, the gNB may also provide a likelihood estimate to the UEs wanting to operate in SL-U, such that these UEs may decide whether to continue operating in unlicensed bands or whether to request for a licensed carrier, or whether to switch to mode 2 operation, e.g., in a different band. The likelihood estimate may be in terms of a probability that the resources proposed by the gNB are available and to be used by the SL UE, e.g., in case the sensing decision made by the gNB may be based on past data, and thus may be outdated. Therefore, a probability estimate may indicate to the SL-UE how well it may trust the grant provided by the gNB and if below a configured or pre-configured threshold, the UE may perform a shorter or longer reevaluation of the resource provided by the grant in order to assure the availability of the resources. Instead of providing a probability, the gNB may also provide a timestamp indicating the age of sensing data used or the age of the grant, so that the SL-UE may decide itself whether to use the grant or not.

### Second Aspect

A second aspect of the present invention provide enhancements or improvements regarding Action 3 described above. The gNB, while not performing any Type-1 LBT or Type-2 LBT procedures, nevertheless, obtains information about the availability of resources in the unlicensed spectrum, e.g., from certain measurements performed by the gNB of from other network entities, like other UEs, that perform a sensing procedure. On the basis of this information, resource recommendations are provided by the gNB for allowing the UE to carry out a light or reduced version of the CAP procedure for checking whether resources indicated in the CG or DG are actually available for the sidelink transmission in the unlicensed spectrum. Thus, in accordance with the second aspect, although the gNB does not perform any Type 1 or Type 2 channel access operations, nevertheless, the gNB may give recommendations to sidelink user devices operating in the unlicensed spectrum, SL-U UEs, which resources or subchannels to avoid or choose for performing the SL-U operation, i.e., the sidelink communication using the unlicensed spectrum. The gNB may receive information about the availability of resources in the unlicensed spectrum, more specifically of the resources in the SL-U RP from reports from other UEs and/or by performing simple measurements on the resources, like measurements of the Receive Signal Strength Indicator, RSSI, or the Reference Signal Received Power, RSRP, or the Signal Noise Ratio, SNR, or the Signal to Noise and Interference Ratio, SINR, on respective bands or subbands in the unlicensed spectrum.

This approach is advantageous, since the gNB may gather information from many surrounding UEs and even non-3GPP RATs operating in its vicinity, which the SL-U UE requesting for a grant might not be aware of. This may be advantageous, since the SL-U UE is moving through different cells, e.g., highly mobile, or may have been in DRX, and may not be aware of the interference situation in its current location, whereas the gNB is very well aware of the current spectrum usage, e.g., also the spectrum usage in the unlicensed spectrum, in its cell. Furthermore, the gNB may have extended sensing capabilities when compared to a UE, e.g., the SL-U UE in particular, since it has more likely better hardware capabilities, e.g., higher receiver sensitivity. Finally, the gNB may also have further interfaces, e.g., may receive information from other UEs in the licensed spectrum via the Uu interface or may receive information from other gNBs via the backhaul, like the X2 interface, or may receive information from the core network, 5GC, and thus may perform a fusion of measurement data, such that is very well aware of the interference situation in this part of the spectrum. Furthermore, the gNB may also merge short-term and long-term sensing data, and thus provide detailed information on when to use or not to use certain parts of the spectrum, e.g., there may be a lot of non-3GPP-RAT traffic during business hours in a certain location.

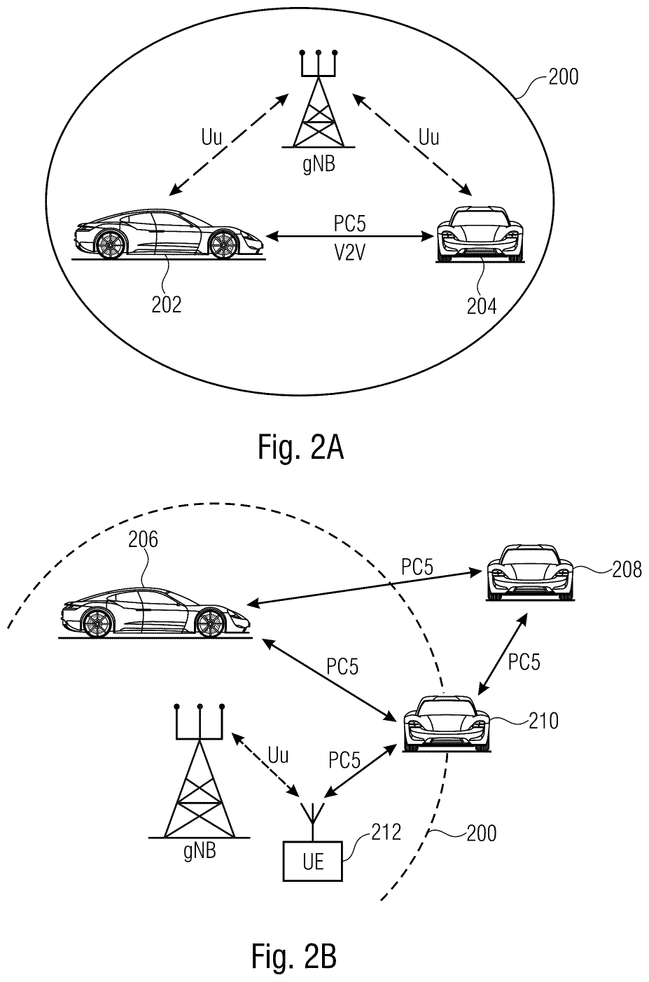

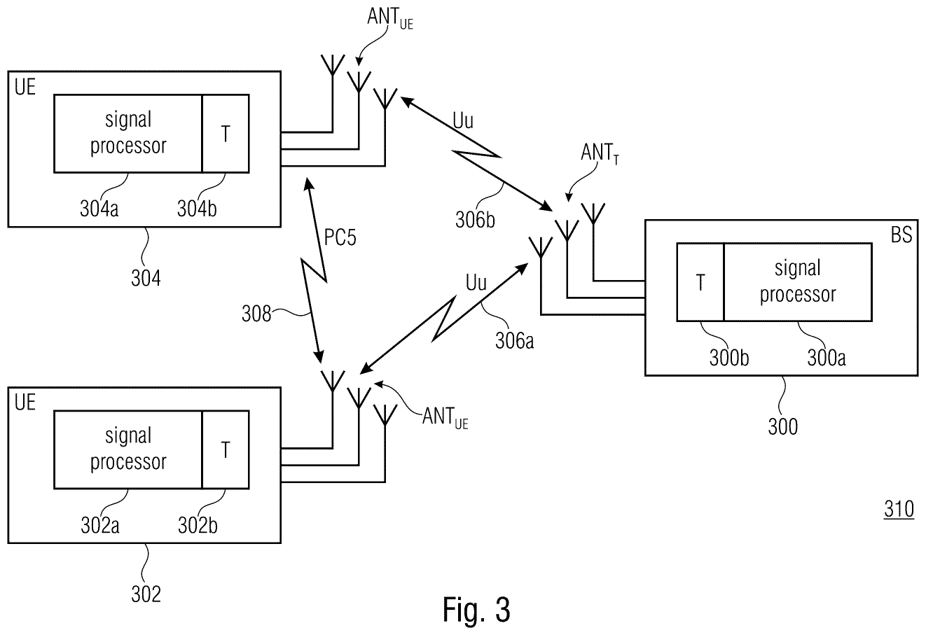

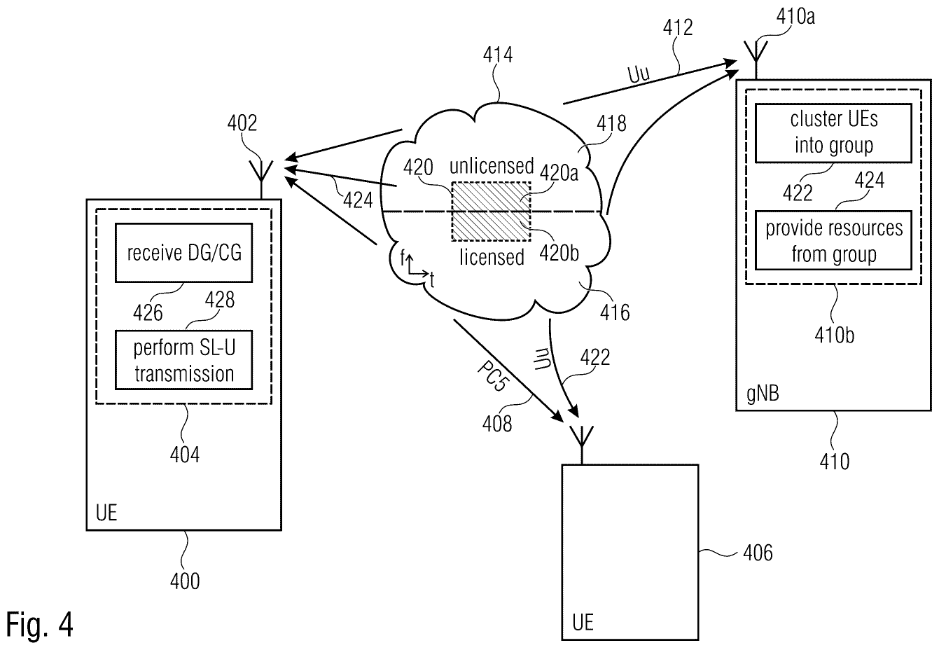

Embodiments of the present invention may be implemented in a wireless communication system as depicted in FIGS. 1A and B, FIG. 2A or FIG. 2B including base stations and users, like mobile terminals or IoT devices. FIG. 3 is a schematic representation of a wireless communication system including a transmitter 300, like a base station, and one or more receivers 302, 304, like user devices, UEs. The transmitter 300 and the receivers 302, 304 may communicate via one or more wireless communication links or channels 306a, 306b, 308, like a radio link. The transmitter 300 may include one or more antennas ANTT or an antenna array having a plurality of antenna elements, a signal processor 300a and a transceiver 300b, coupled with each other. The receivers 302, 304 include one or more antennas ANTUE or an antenna array having a plurality of antennas, a signal processor 302a, 304a, and a transceiver 302b, 304b coupled with each other. The base station 300 and the UEs 302, 304 may communicate via respective first wireless communication links 306a and 306b, like a radio link using the Uu interface, while the UEs 302, 304 may communicate with each other via a second wireless communication link 308, like a radio link using the PC5 or sidelink, SL, interface. When the UEs are not served by the base station or are not connected to the base station, for example, they are not in an RRC connected state, or, more generally, when no SL resource allocation configuration or assistance is provided by a base station, the UEs may communicate with each other over the sidelink. The system or network of FIG. 3, the one or more UEs 302, 304 of FIG. 3, and the base station 300 of FIG. 3 may operate in accordance with the inventive teachings described herein.

### Network Entity

The present invention provides a network entity for a wireless communication network, like a 3^{rd} Generation Partnership Project, 3GPP, network,
wherein the network entity is to serve a plurality of user devices, which are to communicate with each other over a sidelink, SL, using resources from an unlicensed SL resource pool, SL-U RP, the SL-U RP including a plurality of resources from an unlicensed spectrum to be used for SL transmissions,
wherein, for performing a SL transmission on the resources in the unlicensed spectrum by a UE, the network entity is to provide a grant to the UE.

In accordance with embodiments, the network entity provides a grant dependent on one or more of the following:
a clustering of a plurality of UEs into one or more different groups, dependent on properties of the UEs or of the SL transmissions to be performed by the UEs,
measurements on the resources to determine their availability, e.g., by evaluating their occupancy.

In accordance with embodiments, the grant indicates one or more of the following:
resources from the SL-U RP to be used by the UE for performing the SL transmission in the unlicensed spectrum,
resources from the SL-U RP not to be used by the UE for performing the SL transmission in the unlicensed spectrum.

In accordance with embodiments, the grant further indicates a certainty or probability on the availability or non-availability of the resources to be used or not to be used by the UE.

In accordance with embodiments, the network entity is to:
cluster at least some of the plurality of UEs into one or more different groups, dependent on properties of the UEs or of the SL transmissions to be performed by the UEs, and each group including one or more UEs,
assign one or more resources or a subset of resources from within the SL-U RP to each group, and/or
provide the grant to the UE, wherein the grant indicates resources belonging to the one or more resources or subset of resources assigned to the group to which the UE belongs.

In accordance with embodiments, the network entity is to group the UEs into a first group and into a second group dependent on a cast type of the SL transmissions, and wherein the network entity is to grant resources to UEs belonging to the first and/or second group from the resources from their respective groups.

In accordance with embodiments, the cast type is one or more of
a unicast, or
a groupcast, or
a multicast, or
a broadcast.

In accordance with embodiments,
the network entity is to group UEs performing SL transmissions having a priority at or above a configured or preconfigured threshold into a group, and
the network entity is to grant resources from the group for all UEs performing a SL transmission having a priority at or above the threshold.

In accordance with embodiments, the resources granted span one or more subchannels, wherein a number of resources blocks, RBs, within the subchannel is dependent on the priority.

In accordance with embodiments,
the wireless communication network provides a plurality of SL-U RPs having different numerologies, and
the network entity is to grant the resource from a SL-U RP having a certain numerology, the certain numerology depending on a characteristic of the SL transmission.

In accordance with embodiments,
the network entity is to group some of the UEs into a first group of UEs performing SL transmissions having a priority at or above a configured or preconfigured threshold, and into a second group of UEs performing SL transmissions having a priority below the threshold, and
the network entity is to grant resources from
   the first group for all UEs performing a SL transmission having a priority at or above the threshold,
   the second group for all UEs performing a SL transmission having a priority below the threshold.

In accordance with embodiments, the priority of a SL transmission is determined by
a Quality of Service, QoS, profile of a service associated with the SL transmission, or
a packet delay budget, PDB, or latency of the SL transmission, or
a data rate demand or data burst volume, e.g., a peak data rate or average data rate or minimum data rate required for the SL transmission,
an identity of the UE, ID.

In accordance with embodiments,
the network entity is to group some of the UEs into a first group of UEs located closer than a configured or preconfigured distance to the network entity and/or to a further UE, and into a second group of UEs located farther than the distance from the network entity and/or from the further UE, and
the network entity is to grant resources from
   the first group for all UEs located closer than the distance to the network entity and/or the further UE,
   the second group for all UEs father than the distance from the network entity and/or the further UE.

In accordance with embodiments, the network entity is to group one or more UEs based on their location obtained from the UE or from a core network, CN, of the wireless communication network, e.g., from a location management function, LMF, wherein a plurality of groups may be assigned the same set of resources in case their distance is above a defined or predefined threshold, e.g., such that the groups do not interfere with each other.

In accordance with embodiments, the resources provided to each group are orthogonal to each other.

In accordance with embodiments, the resource provided to each group are the same in case one or more of the following holds
the distance between one or more or all of UEs from the first group and one or more or all UEs from the second group is larger than a configured or preconfigured threshold,
all or a minimum set of UEs of the first group have a different zone ID than all or a minimum set of UEs of the second group, wherein the minimum set is larger than 1,
all or a minimum of UEs of a first group have a larger distance from the gNB as compared to all or a minimum of UEs from a second group of UEs, wherein the minimum set is larger than 1
all or a minimum of UEs of the first group have an interference that is smaller than a configured or preconfigured threshold.

In accordance with embodiments, the network entity is to instruct the UEs to perform a channel access procedure, CAP, or a certain type of CAP, or not to perform the CAP only on the resources of the group to which the UE belongs to.

In accordance with embodiments, the network entity is to perform one or more of the following measurements to ensure the availability or unavailability of resources included in the grant:
a measurement of a Reference Signal Receive Power, RSRP, to check whether the resources are occupied by other UEs using the same Radio Access Technology, RAT, as the wireless communication network to which the network entity belongs,
a measurement of a Received Signal Strength Indication, RSSI, or a Signal to Noise Ratio, SNR, or a Signal to Noise Interference Ratio, SINR to check whether the resources are occupied UEs using a RAT different from the RAT used by the wireless communication network to which the network entity belongs,
a decoding of control messages transmitted on the resource, e.g., 3GPP downlink control information, DCI, or 3GPP sidelink control information, SCI, or an IEEE 802.11 Physical Layer Convergence Protocol, PLCP, header, or an extraction of information on one or more transmissions, like ongoing or upcoming transmissions or a remaining duration of an ongoing transmission,
a decoding of assistance information, AIM.

In accordance with embodiments, the network entity, on performing measurements on resources, includes resources in the grant only if the resources are ascertained to be available, depending on whether the resulting measurement is equal to or below a defined or predefined threshold.

In accordance with embodiments, the network entity, on performing measurements on resources, includes resources in the grant only if the resources are ascertained to be unavailable, depending on whether the resulting measurement is above a defined or predefined threshold.

In accordance with embodiments, based on the identified availability of the resources in the grant, the network entity is to indicate to the UE a CAP to be used or not to be used.

In accordance with embodiments, based on the identified availability of the resources in the grant, the network entity is to indicate to the UE one or more of the following:
a certain type of CAP, in case the measurement is below a certain threshold, e.g., a first CAP if the measurement is equal to or below a certain threshold, and a second CAP if above the certain threshold,
not to perform CAP for use of the resources in the grant,
use of resources in the grant only for transmissions having a certain priority.

In accordance with embodiments, the network entity is to provide the resources included in the grant responsive to
a resource request or a SL buffer status report, BSR, from the UE, or
a request from the UE requesting the network entity to provide a new grant including other resources, or
a request from the UE to perform a retransmission, or
a collision indication from the UE, or
a request from a UE assisting another UE, e.g., a UE providing a preferred and/or non-preferred set of resource to another UE via an inter-UE coordination information, IUC, message or via an assistance information message, AIM.

In accordance with embodiments, the request from the UE requesting the network entity to provide the new grant includes a certain condition under which the UE is to be supported using resources from a licensed spectrum, and, responsive to the request, the network entity is to configure the UE such that the UE is able to switch, based on the condition, to resources from the licensed spectrum.

In accordance with embodiments, the network entity is to identify the availability of the resources to be included in the grant based on
sensing the resources in the SL-U RP, and/or
assistance information messages received at the network entity which indicate for the resources in the SL-U RP an occupancy status, and/or
assistance information received from a different network entity or from a core network, CN, entity, e.g., a network function, NF, such as a spectrum database, and/or
a non-3GPP sensing device, e.g., a WiFi access point integrated in the network entity or having an interface to the network entity.

In accordance with embodiments, the network entity is to identify the availability of the resources to be included in the grant responsive to a resource request or a SL buffer status report, BSR, from the UE.

In accordance with embodiments, for identifying the resources in the SL-U RP, the network entity is to perform the one or more to the following:
a detection of one or more energy levels on the resources, e.g., a Received Signal Strength Indication, RSSI, a Signal to Noise Ratio, SNR, or a Signal to Noise Interference Ratio, SINR,
a measurement of pilot symbols transmitted on the resources and/or a determination of one or more measured values, e.g., a 3GPP Reference Signal Receive Power, RSRP, or a 3GPP Reference Signal Received Quality, RSRQ,
a decoding of sidelink assistance information messages, AIMs,
a decoding of control messages transmitted on the resources, e.g., 3GPP sidelink control information, SCI, or an IEEE 802.11 Physical Layer Convergence Protocol, PLCP, header, and an extraction of information on one or more transmissions, like ongoing or upcoming transmissions or a remaining duration of an ongoing transmission.

In accordance with embodiments, the network entity is to provide the indication on the availability of the resources using on or more of:
in the grant provided to the UE, or
using a higher layer signaling, like a MAC CE or a PC5 RRC, or
using a resource pool, RP, configuration indicating a subset of resources within the SL-U RP where the network entity performs measurements at regular intervals to check for their availability, wherein the network entity is to indicate an availability or non-availability of the subset of resources to the UE, e.g., by using higher layer signaling, or
using a broadcast signal, e.g., MIB or SIB.

In accordance with embodiments, a CAP, which the UE is expected to perform, includes one or more to the following:
a Listen-Before-Talk, LBT, procedure on the resource,.
a detection of one or more energy levels on the resource, e.g., a Received Signal Strength Indication, RSSI, a Signal to Noise Ratio, SNR, or a Signal to Noise Interference Ratio, SINR,.
a measurement of pilot symbols transmitted on the resource and/or determination of one or more measured values, e.g., a 3GPP Reference Signal Receive Power, RSRP, or a 3GPP Reference Signal Received Quality, RSRQ,
a decoding of a sidelink assistance information message, AIM,
a decoding of control messages transmitted on the resource, e.g., 3GPP sidelink control information, SCI, or an IEEE 802.11 Physical Layer Convergence Protocol, PLCP, header, and an extraction of information on one or more transmissions, like ongoing or upcoming transmissions or a remaining duration of an ongoing transmission.

In accordance with embodiments, the LBT, procedure comprises:
a type-1 CAP that senses the resource for the SL transmission for a random time duration, or
a type-2A CAP that senses the resource for the SL transmission for 25 μs, or
a type-2B CAP that senses the resource for the SL transmission for 16 μs,
a type-2C CAP that does not sense the resource for the SL transmission, or
a new type of CAP that senses a channel for the SL transmission with a configured or preconfigured time duration.

In accordance with embodiments, the CAP evaluates, based on sensing, an availability of a channel for performing the SL transmissions, wherein a certain duration of the channel is considered to be idle when the channel is sensed during the certain duration and when it is determined that a detected power for at least a certain time within the certain duration is less than an energy detection threshold, otherwise, the certain channel is considered to be busy.

### User Device

The present invention provides a user device, UE, for a wireless communication network, like a 3^{rd} Generation Partnership Project, 3GPP, network,
wherein the UE is served by a network entity and is to communicate with other UEs over a sidelink, SL, using resources from an unlicensed SL resource pool, SL-U RP, the SL-U RP including a plurality of resources from an unlicensed spectrum to be used for SL transmissions,
wherein, for performing a SL transmission on the resources in the unlicensed spectrum, the UE is to receive from the network entity a grant, the grant indicating the resources from the SL-U RP to be used by the UE for performing the SL transmission in the unlicensed spectrum.

In accordance with embodiments,
in addition to the grant, the UE is to receive from the network entity an indication on the availability of the resources included in the grant, and/or an indication on the measurements the network entity performs on the resources before including them in the grant, and/or
in case the resources currently granted for the SL transmission or granted to another UE for a feedback transmission are not feasible, the UE is to request from the network entity to provide a new grant, and/or
the UE is to provide a report including other resources together with an indication on the availability of the resources included in the new grant.

In accordance with embodiments, the UE is to request from network entity to provide the grant, dependent on one or more of the following:
a resource request or a SL buffer status report, BSR, or
a collision indication, or
a request to assist another UE, e.g., the UE intending to provide a preferred and/or non-preferred set of resource to another UE via an inter-UE coordination information, IUC, message or via an assistance information message, AIM,
a determined occupancy status of the resources currently granted,
a number of failed CAPs/LBTs on the currently granted resources,
in case the UE is a transmitting UE and does not receive an acknowledgement from a receiving UE within a certain period, wherein the request is a request to the network entity to provide the new grant to the receiving UE.

In accordance with embodiments, the request for the new grant includes a certain condition under which the UE is to be supported using resources from a licensed spectrum, and wherein the UE is to receive from the network entity a configuration enabling the UE to switch, based on the condition, to resources from the licensed spectrum.

In accordance with embodiments, the UE is to request from the network entity a likelihood estimate, and wherein, dependent on a received likelihood estimate, the UE is to decide whether to continue operating in unlicensed bands or whether to request for a licensed carrier, or whether to switch to mode 2 operation, e.g., in a different band.

### System

The present invention provides a wireless communication system, like a 3^{rd} Generation Partnership Project, 3GPP, system, comprising a one or more of the inventive user devices, UEs, and/or one or more of the inventive network entities.

In accordance with embodiments, the UE comprise one or more of a power-limited UE, or a hand-held UE, like a UE used by a pedestrian, and referred to as a Vulnerable Road User, VRU, or a Pedestrian UE, P-UE, or an on-body or hand-held UE used by public safety personnel and first responders, and referred to as Public safety UE, PS-UE, or an IoT UE, e.g., a sensor, an actuator or a UE provided in a campus network to carry out repetitive tasks and requiring input from a gateway node at periodic intervals, or a mobile terminal, or a stationary terminal, or a cellular IoT-UE, or a SL UE, or a vehicular UE, or a vehicular group leader UE, GL-UE, or a scheduling UE, S-UE, or an IoT or narrowband IoT, NB-IoT, device, or a ground based vehicle, or an aerial vehicle, or a drone, or a moving base station, or road side unit, RSU, or a building, or any other item or device provided with network connectivity enabling the item/device to communicate using the wireless communication network, e.g., a sensor or actuator, or any other item or device provided with network connectivity enabling the item/device to communicate using a sidelink the wireless communication network, e.g., a sensor or actuator, or any sidelink capable network entity.

In accordance with embodiments, the base station comprises one or more of a macro cell base station, or a small cell base station, or a central unit of a base station, or a distributed unit of a base station, or an Integrated Access and Backhaul, IAB, node, or a road side unit, RSU, or a UE, or a SL UE, or a group leader UE, GL-UE, or a relay or a remote radio head, or an AMF, or an SMF, or a core network entity, or mobile edge computing, MEC, entity, or a network slice as in the NR or 5G core context, or any transmission/reception point, TRP, enabling an item or a device to communicate using the wireless communication network, the item or device being provided with network connectivity to communicate using the wireless communication network.

### Methods

The present invention provides a method for operating a network entity for a wireless communication network, like a 3^{rd} Generation Partnership Project, 3GPP, network, the method comprising:
serving, by the network entity, a plurality of user devices, which are to communicate with each other over a sidelink, SL, using resources from an unlicensed SL resource pool, SL-U RP, the SL-U RP including a plurality of resources from an unlicensed spectrum to be used for SL transmissions, and
providing, by the network entity, a grant to the UE for performing a SL transmission on the resources in the unlicensed spectrum by a UE.

The present invention provides a method for operating a user device, UE, for a wireless communication network, like a 3^{rd} Generation Partnership Project, 3GPP, network, wherein the UE is served by a network entity and is to communicate with other UEs over a sidelink, SL, using resources from an unlicensed SL resource pool, SL-U RP, the SL-U RP including a plurality of resources from an unlicensed spectrum to be used for SL transmissions, the method comprising:
receiving from the network entity a grant for performing a SL transmission on the resources in the unlicensed spectrum, the grant indicating the resources from the SL-U RP to be used by the UE for performing the SL transmission in the unlicensed spectrum.

### Computer Program Product

Embodiments of the first aspect of the present invention provide a computer program product comprising instructions which, when the program is executed by a computer, causes the computer to carry out one or more methods in accordance with the present invention.

Embodiments of the inventive aspect are now described in more detail with reference to the accompanying drawing. It is noted that the subsequently outlined and described aspects or embodiments may be combined such that some or all of the aspects/embodiments are implemented within one embodiment. Further, it is noted that when referring to “resources”, in this description, a resource is to be understood as comprising one or more of the following:
one or more symbols,
one or more time slots or subframes or frames,
one or more frequencies or carriers or subchannels or group of subchannels,
one or more frequency bands, like unlicensed subbands,
one or more bandwidth parts,
one or more resource pools,
one or more LBT subbands,
one or more spatial resources, e.g., using spatial multiplexing.

### First Aspect

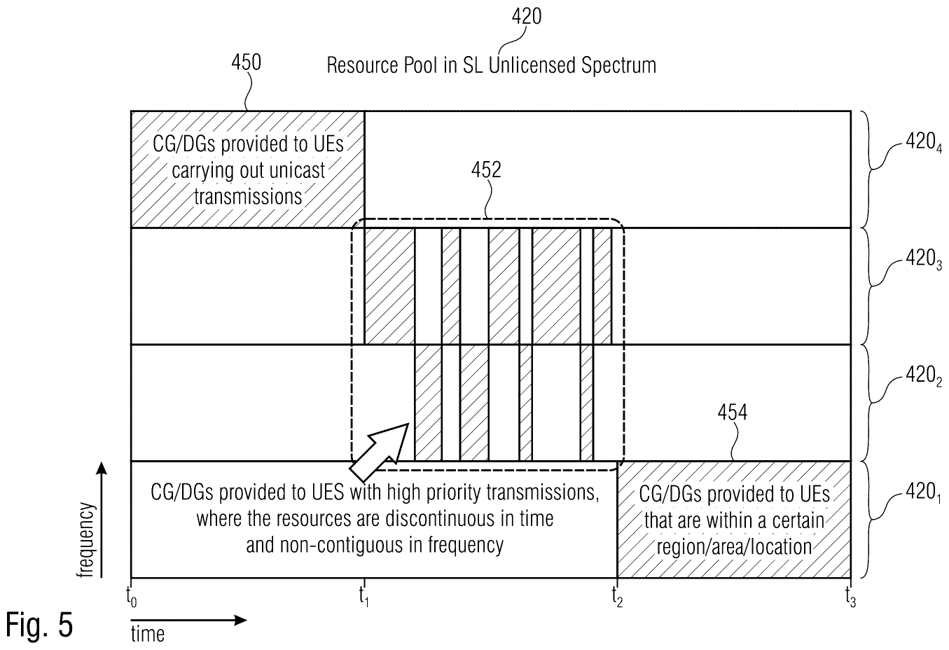

FIG. 4 illustrates a user device, UE, also referred to as sidelink UE, SL-UE, 400 which comprises one or more antennas 402 and a signal processor 404 for performing one or more operations, for example operations involving the antenna 402, like transmitting/receiving data, like payload data or control data or inter-UE coordination (IUC) messages. UE 400 is operated in a wireless communication system, like the one descried above with reference to FIGS. 1A and B to FIG. 3, for example a 3^{rd} generation partnership project, 3GPP, system or network. UE 400 is to communicate with other UEs, like UE 406, using the sidelink or PC5 interface, as is schematically illustrated at 408. UE 400 operates in Mode 1 and is connected to a base station or gNB 410. The gNB 410 includes a signal processor 410b and one or more antennas 410a for the wireless communication with the other network entities, like UEs 400 and 406. When operating in Mode 1, UE 400 and UE 406 receive via the Uu interface 412 resource pool configurations for the UE 400 and UE 406 to communicate with each other. Within these configured resource pools, resources are allocated by the gNB 410 that are to be used or that are explicitly not to be used by the UEs 400, 406 for the communication over the sidelink 408.

FIG. 4 further illustrates, schematically, the spectrum 414, like the radio spectrum including the resources to be used or not to be used for a communication within the wireless communication system or network. The resources available for the SL communication may comprise one or more of the following: one or more symbols, one or more time slots or subframes or frames, one or more resource blocks (RBs) or frequencies or carriers or subchannels or group of subchannels, one or more frequency bands. As is further illustrated, schematically, the spectrum 414 comprises the licensed spectrum 416 and the unlicensed spectrum 418. The licensed spectrum 416 is the part of the spectrum that is reserved for the wireless communication system including the UEs 400 and 406 as well as the base station 410. In other words, resources in the licensed spectrum are for exclusive use by this wireless system, as defined by regulatory bodies and entities. The unlicensed spectrum 418 includes resources that may be used by a plurality of wireless communication systems, for example by another wireless communication system in accordance with the 3GPP standard but operated by a different operator, or by systems using a different radio access technology, like WiFi or Bluetooth. For the sidelink communication a resource pool 420, also referred to as sidelink resource pool, SL-RP, may be provided, and the UE 400 is configured or preconfigured with the resource pool 420. Although the figure depicts only a single resource pool, multiple such resource pools may be configured or preconfigured. The resource pool may include resources 420a from the unlicensed spectrum 418 only or from the licensed spectrum 416 only, or, as is depicted in the embodiment of FIG. 4, may comprise resources 420a from the licensed spectrum 416 and resources 420b from the unlicensed spectrum 420. The resources in the unlicensed spectrum may be aggregated using carrier aggregation.

In accordance with the first aspect of the present invention a high-level resource coordination by a base station is provided when granting resources for a sidelink communication in the unlicensed spectrum. Embodiments of the present invention provide a network entity, like the gNB 410, for a wireless communication network, like a third generation partnership project, 3GPP, network. The gNB 410 serves a plurality of user devices, like UE 400 and UE 406, which communicate with each other over the sidelink 408 using resources from the unlicensed SL resource pool 420 which includes a plurality of resources from an unlicensed spectrum 420a to be used for the SL transmissions. For performing a SL transmission on the resources in the unlicensed spectrum 420a, for example by UE 400, the gNB 410 provides a grant, like a DG or a CG, to the UE 400. The grant indicates the resources from the SL-U RP 420 to be used by UE 400 for performing the SL transmission in the unlicensed spectrum 420a. UE 400 is expected to carry out a channel access procedure, CAP, on the resources indicated in the grant, for example, a LBT procedure. The gNB 410, as indicated at 422 clusters at least some of the plurality of UEs into one or more different groups. This is dependent on the properties of the UEs or on the properties of the SL transmissions to be performed by the UEs. Each group has a subset of the resources in the SL-U RP, and each group includes at least one UE. Thus, as soon as the property of the UE or the property of a SL transmission for which a grant is requested is known, the gNB 410, as is indicated at 424, provides to UE 400 which requested the grant the resources from the group with which gNB 410 associated UE 400. gNB 410 transmits, via the Uu interface 412, the DG or the CG including the resources from the group. UE 400, as is indicated at 426, receives the DG or CG and, as is indicated at 428, performs the SL-U transmission, for example a sidelink transmission over the sidelink 408 to sidelink UE 406.

Thus, in accordance with embodiments, the gNB 410 may cluster the UEs 400, 406 into different groups and provides CGs or DGs to the UEs 400, 406 based on the grouping. The resources provided to each group may be orthogonal to each other and the smallest number of UEs within a group may be a single UE.

In accordance with embodiments, the grouping may be based on the cast type, e.g., unicast or groupcast or broadcast. For example, the gNB 410 may provide CGs or DGs to all UEs performing a unicast transmission while providing different CGs and DGs to UEs performing groupcast transmissions. In other words, dependent on the cast type, different CGs or DGs, i.e., different grants including different resources from the resource pool, are provided to the UEs.

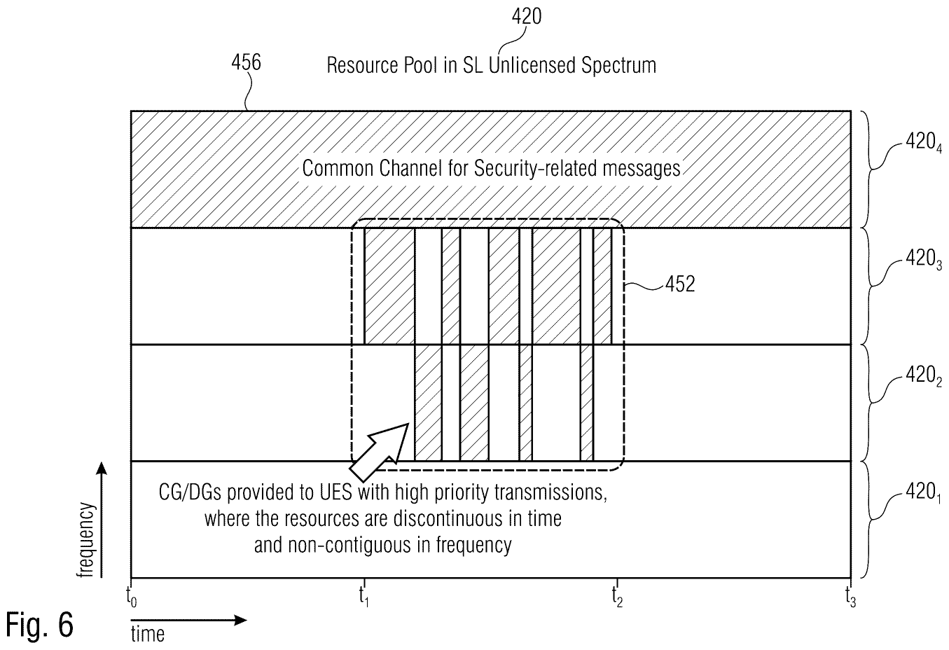

FIG. 5 schematically illustrates an SL-U RP 420 including, in the depicted embodiments, only resources 420a from the unlicensed spectrum 418 which are provided to UEs, like UE 400 or UE 406 using CGs or DGs based on certain criteria. FIG. 5 illustrates an embodiment in which the resource pool 420 includes four subbands 420₁ to 420₄ in the unlicensed spectrum, each subband having a certain bandwidth. In accordance with the just described embodiments, the gNB 410 clusters UEs into different groups based on the cast type so that, as is illustrated at 450 in FIG. 5, UEs performing a unicast transmission are clustered into a group of UEs receiving resources from the area 450 of the resource pool which, in the depicted embodiment, uses resources at the beginning of the fourth subband 420₄ until a time t₁. All UEs not performing a unicast, in accordance with the depicted embodiment, may receive grants including resources from any other part of the resource pool 420, except for certain parts, if present, which are associated with UEs or sidelink transmissions having other properties than the cast type. For example, UEs not performing a unicast transmission may receive grants indicating resources in the first subband 420₁ unit a time t₂ or from the second subband 420₂ during a time t₀ until the time t₁ and from the time t₂ until the time t₂₃, or in the third subband 420₃ from the time t₀ to the time t₁ or from the time t₂ until the time t₃, or in the fourth subband 420₄ during the time t₁ to the time t₃.

This approach is advantageous, since this type of user clustering or user grouping decreases a usage of the spectrum by reducing interference within certain regions of the spectrum. Consequently, LBT-failures decrease and thus make SL-U communication more efficient, e.g., reduces latency.

While FIG. 5 illustrates the area 450 as continuous resources in time and frequency to be used for unicast transmissions, it is noted that in accordance with other embodiments, the resources may also be non-continuous in time and/or non-continuous in frequency.

In accordance with other embodiments, the grouping may be based on a priority of the transmissions a UE intends to carry out. For example, all UEs having a transmission with a priority higher than a configured or preconfigured threshold may be provided with resources belonging to a certain part of the resource pool, as assigned by the gNB. In FIG. 5, this embodiment is illustrated at 452 in accordance with which non-continuous resources in time and frequency are provided in the second and third subband 420₂, 420₃ between times t₁ and t₂ which are to be used by UEs for high priority transmissions, i.e., transmissions with a priority above the mentioned threshold. Other transmissions with a lower priority may receive grants including resources from the other available parts of the subbands, for example from the first subband 420₁ between times t₀ and t₂ or from subbands 420₂ and 420₃ between times t₀ and t₁ and between times t₂ and t₃, or from the fourth subband 420₄ during the times from t₂₁ to t₃. In accordance with the depicted embodiments, the resources are discontinuous in time and noncontinuous in frequency, as is indicated by the hatched regions in the subbands in area 452. However, in accordance with other embodiments, the resources may be continuous in time and/or continuous in frequency, for example in a way as depicted at 450 with regard to the previous embodiment.

Further, resources for transmissions with a lower priority may be taken from the parts in section 452 in FIG. 5 between the hatched portions.

In accordance with embodiments, the priority may be linked to
a quality of service, QoS profile, for example to a QoS profile related to a particular service, e.g., URLLC service or IioT or IoT or mMTC service, or
a certain identity, ID, of a UE, or
a packet delay budget, PDB, of a transmission, or
a quota, e.g., a data rate demand, e.g., such as a minimum, average or maximum data rate demand, or
a location, e.g., a zone ID or area having a configured 2D or 3D coordinate or mesh,
a distance, e.g., a distance from a gNB or a distance between UEs, e.g., a minimum required communication range.

In accordance with other embodiments, the grouping may be based on a location or position of the UEs 400, 406 within the area served by the gNB 410. For example, UEs that are located farther away from the gNB 410 may be allocated a first band, while UEs that are located closely to the gNB 410 may use a second band for easier access. In this way, the interference between SL-U UEs belonging to different groups is reduced, resulting in LBT failures within the unlicensed band. In FIG. 5, at 454, the first subband 420₁ between the time t₂ and t₃ is used to provide resources for a CG or a DG to a UE that is within a certain region or area or location, for example that is within a certain distance from the gNB 410 or in a certain predefined area or zone. UEs located at other regions or areas or locations may have assigned a different part of the resource pool 420, or all UEs not fulfilling the criteria to receive resources from area 454 may receive resources from other parts of the resource 420, unless it is a part reserved for other groups. In the example of FIG. 5, UEs not being within a location associated with resources from area 454 may receive in the grants resources from the remaining parts of the subbands, for example from subband 420₁ between the times t₀ and t₂, from the subbands 420₂ and 420₃, between the times t₀ and t₁ and between the times t₂ and t₃ and from the fourth subband 420₄ between the times t₁ and t₃.

In accordance with yet further embodiments, the gNB 410 may cluster the one or more UEs dependent on their need to communicate with each other via the SL-U, i.e., to perform SL communications in the unlicensed spectrum. For example, the gNB 410 may have knowledge about where the UE is located, for example, in case of a UE operating in Mode 1, or by a query to the core network, CN, for example a query to the location management function, LMF. Based on the knowledge of the UEs location or position within the cell, the gNB 410 may recommend, as shown at 454, certain resources or subchannels to be used for such UEs. This allows the UEs to more easily detect messages from each other, for example, V2X messages concerning road safety.

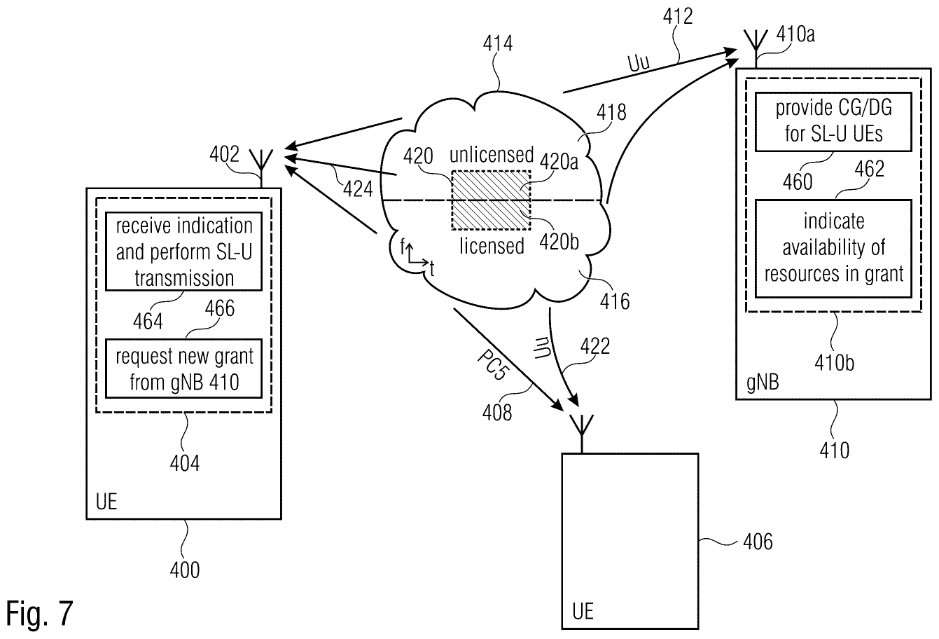

In accordance with further embodiments, a certain property of a transmission to be performed may form the basis for the grouping, for example, security-related (or safety-related) messages may be mandated to be transmitted in certain parts of the spectrum so as to increase the probability that all UEs within a certain area may receive such a message. FIG. 6 illustrates such an embodiment in accordance with which the fourth subband 420₄ of the resource pool 420, which, like in FIG. 5, only includes resources in the unlicensed spectrum, is used as a common channel 456 for security-related messages. In the embodiment of FIG. 6 another part 452 which is in bands 420₂ and 420₃ between times t₁ and t₂ is used for high priority transmissions in a way as described above with reference to FIG. 5. Thus, any UE within the coverage of the gNB 410 that has a security-related message to be transmitted receives a grant with resources in the fourth subband 420₄ while all other messages to be transmitted receive grants in the first to third subbands 420₁ to 420₃ with high priority transmissions receiving resources from section 452 while non-high priority messages receive resources from the remaining parts of the resource pool, namely from the entire first subband 420₁ and from the second and third subbands 420₂ between times t₀ and t₁ and between times t₂ and t₃. Note that security-related messages may refer to road safety in the context of V2X, or flight control, in case of UAVs. Furthermore, depending on the relevance of the safety message, it may be advantageous to transmit the message in a general, e.g., a separate or common channel for security-related messages (456). In case the message only concerns a very localized scenario, a distinct part of the spectrum used for a certain zone, e.g., (454), might be more efficient, since the load on a common safety channel (456) is reduced.

Providing the common channel 456 is advantageous as it allows devices with reduced capabilities, e.g., RedCap devices, to receive and decode messages of high priority or importance and, further, allows such RedCap devices to forward security-related messages to other entities in the network, like other base stations, user devices, road side units or gateways to allow collecting important data included in the security-related messages at such network entities.

It is noted that FIG. 5 and FIG. 6 are only examples for implementing the inventive approach in accordance with the first aspect of the present invention. Naturally, the present invention is not limited to such embodiments and other parts of the resource pool 420 may be allocated to certain types of UEs or certain types of transmissions. For example, in FIG. 6, resources dependent on the cast type, like resources 450 in FIG. 5, may be provided also on one or more of the subbands illustrated in FIG. 6 as well as resources associated with UEs at certain locations as indicated at 454 in FIG. 5.

In accordance with the further embodiments, the gNB 410 may instruct the UE 400, 406 to perform a CAP, like an LBT procedure, only on the bands or resources indicated in the grant, for example, in the bands or resources as indicated in FIG. 5 and FIG. 6 dependent on the properties of the UE and/or the SL transmission wherein the respective bands or resources, advantageously, are orthogonal. Further, the gNB 410, in accordance with other embodiments, may provide some sort of resource or frequency hopping which improves the probability of a UE performing a successful LBT. The resource or frequency hopping may be enabled by the use of interlacing or the assignment of different subchannels/subbands using the FRIV indicated in DCI for DGs. This increases frequency diversity and thus reduces the chance of LBT failures.

Further advantages of the first aspect are a reduction in the sensing or decoding efforts at the UE since UEs, like NR SL-UEs may exclude certain bands or subchannels from blind decoding or just blind decode non-recommended bands dependent on their battery status or processing capabilities. This is because the UE may completely avoid sensing and blind decoding or at least reduce the amount of sensing and/or blind decoding of the recommended bands since the gNB has already performed this action on the recommended bands. On the other hand, the UE has to perform sensing on the non-recommended bands, since the gNB has not done so already and the UE does not have any prior information on the availability of resource on these bands. For example, when considering FIG. 5, such UEs may only perform blind decoding in the subband or subchannel 420₁ of the resource pools 420 adavantageously only during the time interval between t₂ and t₃, thereby reducing the decoding efforts. Likewise, a UE transmitting such messages to another UE has to send the respective messages only on the resources 454 in the resource pool of FIG. 5 so that the transmission takes place in resources within only one subband, thereby reducing the sensing efforts at the receiving UE, since the transmission is restricted to a narrower frequency range in subband or subchannel 420₁. Note that reducing sensing efforts increases the battery lifetime of a UE, which might be critical under certain conditions, e.g., in case the battery of a pedestrian UE is low and it may still receive safety-related messages.

### Second Aspect

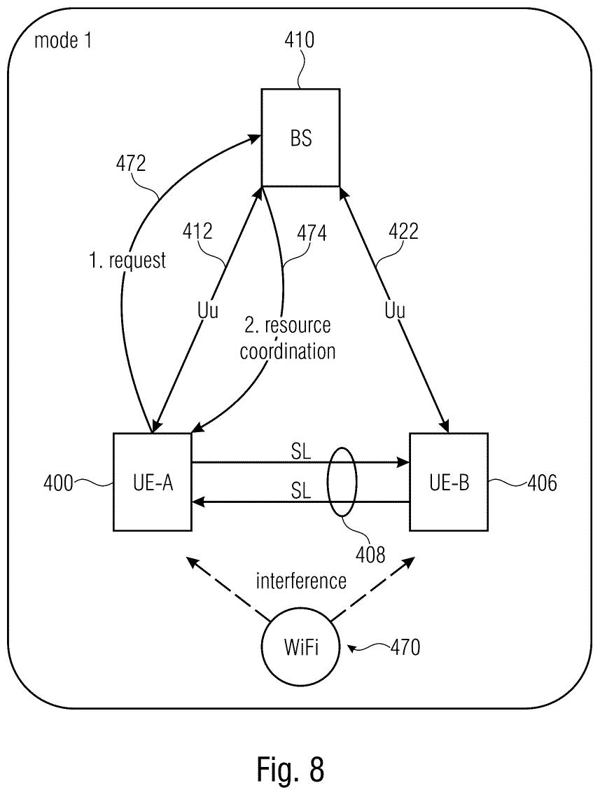

FIG. 7 illustrates a user device, UE, also referred to as sidelink UE, SL-UE, 400 which comprises one or more antennas 402 and a signal processor 404 for performing one or more operations, for example operations involving the antenna 402, like transmitting/receiving data, like payload data or control data or inter-UE coordination (IUC) messages. UE 400 is operated in a wireless communication system, like the one descried above with reference to FIG. 1 to FIG. 3, for example a 3^{rd} generation partnership project, 3GPP, system or network. UE 400 is to communicate with other UEs, like UE 406, using the sidelink or PC5 interface, as is schematically illustrated at 408. UE 400 operates in Mode 1 and is connected to a base station or gNB 410. The gNB 410 includes a signal processor 410b and one or more antennas 410a for the wireless communication with the other network entities, like UEs 400 and 406. When operating in Mode 1, UE 400 and UE 406 receive via the Uu interface 412 resource pool configurations for the UE 400 and UE 406 to communicate with each other. Within these configured resource pools, resources are allocated by the gNB 410 that are to be used or that are explicitly not to be used by the UEs 400, 406 for the communication over the sidelink 408.

FIG. 7 further illustrates, schematically, the spectrum 414, like the radio spectrum including the resources to be used or not to be used for a communication within the wireless communication system or network. The resources available for the SL communication may comprise one or more of the following: one or more symbols, one or more time slots or subframes or frames, one or more resource blocks (RBs) or frequencies or carriers or subchannels or group of subchannels, one or more frequency bands. As is further illustrated, schematically, the spectrum 414 comprises the licensed spectrum 416 and the unlicensed spectrum 418. The licensed spectrum 416 is the part of the spectrum that is reserved for the wireless communication system including the UEs 400 and 406 as well as the base station 410. In other words, resources in the licensed spectrum are for exclusive use by this wireless system, as defined by regulatory bodies and entities. The unlicensed spectrum 418 includes resources that may be used by a plurality of wireless communication systems, for example by another wireless communication system in accordance with the 3GPP standard but operated by a different operator, or by systems using a different radio access technology, like WiFi or Bluetooth. For the sidelink communication a resource pool 420, also referred to as sidelink resource pool, SL-RP, may be provided, and the UE 400 is configured or preconfigured with the resource pool 420. Although the figure depicts only a single resource pool, multiple such resource pools may be configured or preconfigured. The resource pool may include resources 420a from the unlicensed spectrum 418 only or from the licensed spectrum 416 only, or as is depicted in the embodiment of FIG. 7, may comprise resources 420a from the licensed spectrum 416 and resources 420b from the unlicensed spectrum 420. The resources in the unlicensed spectrum may be aggregated using carrier aggregation.

In accordance with second aspect of the present invention, the gNB 410 serving the UEs 400, 406 provides resource recommendations from within the SL-RP 420. More specifically, as is indicated in FIG. 7 at 460, gNB 420 provides a grant, like a CG or a DG for one or more of the UEs 400, 406 from the unlicensed spectrum 418, for example, from the resource pool 420 including such resources 420a. In addition, as is indicated at 462, UE 410 provides an indication of the availability of the resources included in the grant provided to the respective UEs. The indication may be implicitly based on the simple action that gNB 410 is providing resources 420a using a grant, or it may be explicitly indicated within the grant that the resources have been checked for their availability. For example, despite the fact that the gNB 410 does not perform any Type 1 or Type 2 channel access operations regarding the resources 420a in the unlicensed band 418, gNB 410 may, nevertheless, perform some simple measurements on the bands or resources in the unlicensed spectrum, like RSSI, RSRP, SNR, or SINR measurements. In accordance with other embodiments, as an alternative or in addition to the measurements, the gNB 410 may receive information about the availability of resources in the unlicensed spectrum from other UEs that perform a sensing operation on the resources. The gNB 420 receiving such additional information, for example, via assistance information messages, AIM, or higher layer reporting like measurement reports, may use this additional information alone or in combination with the own measurements for giving a recommendation to the respective SL-UEs 400, 406 which receive a certain grant so as to indicate which resources or subchannels in the unlicensed band 418, which are indicated in the grant, are to be avoided or are to be chosen for performing the SL-U operation, i.e., the SL transmission using the resources from the unlicensed spectrum 418.

The IUC message or AIM may contain one or more of: a set of preferred resources for a transmission over the SL, a set of non-preferred resources for a transmission over the SL, a collision indication. The collision indication may be as specified in Release 17, where a first UE detects a possible resource collision for a single future resource reserved by both a second and a third UE. The first UE then sends a collision indication to either the second or third UE, which may be only a 1 bit indication on the PSFCH informing the UE to not use the reserved resource. This may be considered essentially a single non-preferred resource that the second/third UE it to avoid/not use.

In accordance with embodiments, based on a resource request or a SL BSR from a UE 400 received over the Uu interface 412 at the gNB 410, the gNB 410 may identify those resources within the configured or pre-configured resource pool 420 that are available and may measure the RSRP on these resources to make sure that they are not used by other UEs, like other LTE or NR UEs or other LTE-U or NR-U UEs. Further, the gNB 410 may measure the RSSI or SNR or SINR on the resources to make sure that there are no devices using a different radio access technology, RAT, than the RAT used by the gNB 410, which are currently using the resources, like devices using Wi-Fi or Bluetooth access technologies. Thus, in accordance with the second aspect of the present invention, the gNB 410 provides the UEs 400, 406 which receive the grants for a sidelink transmission over the unlicensed spectrum with additional confidence that the resources from the unlicensed spectrum 418 are indeed available for the transmissions.

In accordance with embodiments, the recommendation may be added to the already existing grants based on a resource request or BSR from the UE. In other words, the CG or DG as provided by gNB 410 to the UE 400 may also include the indication regarding the availability of the resources mentioned in the grant explicitly, or implicitly, where the mere fact that the gNB 410 is including these resources in the CG or DG is indicative that the resources are available for use by the UE 400. In accordance with other embodiments, this information or recommendation may be provided using higher layer signaling, like a MAC control element, MAC CE, or a PC5 RRC signaling. It is also possible for the gNB 410 to check for the availability of all resources within a resource pool or a mini resource pool, with a smaller number of subchannels, e.g., 1 or 2 subchannels with the minimum number of 10 PRBs, by performing the aforementioned measurements and provide the UE with such resource pool configurations using RRC signaling, specifically using RRC information elements.

In accordance with further embodiments, based on the knowledge the gNB 410 has about the availability of the resources indicated in the grant, for example on the basis of the above-mentioned measurements performed by the gNB, the gNB 410 may also recommend a type of CAP, like the type of LBT procedure, to be used by the UE which requested the grant. For example, if the RSSI, SNR, or SINR measurement is below a certain threshold, gNB 410 may recommend the UE to perform a Type-2 LBT procedure. Since the measurement value is below the threshold, the resources or frequency bands or subchannels seem to be less occupied so that the Type-2 LBT procedure may be applied for carrying out the transmission. The reasoning behind this selection of LBT procedure is that since the channel was deemed available by the gNB when performing the CAP, the UE need not spend more effort in checking the availability of the resources indicated in the grant. Instead, the UE may either not perform a CAP or perform a CAP with a short duration, like a Type 2 LBT, where the duration varies from 16 μs (Type 2B), 25 μs (Type 2A) or no LBT but wait for a duration of 584 μs (Type 2C).

If the RSSI or SNR or SINR measurements are above a certain threshold, the resources are considered to be highly occupied so that the gNB 410 recommends to the UE to use this resource only for transmissions, for example, by performing a Type-1 LBT or CAP procedure. This is because the gNB has deemed the resources to be used by other UEs (3GPP or non-3GPP RATs) and hence if the UE wants to use them, it needs to check whether the resources are indeed available by performing an LBT of longer duration, like the Type 1 LBT. It is also possible for the gNB 410 to recommend the UE to not use these resources if it considered them to be highly occupied and the UE may not be able to carry out a transmission successfully.

In accordance with yet other embodiments, based on the knowledge at the gNB 410 about the availability of the resources in a grant, the gNB 410 may recommend using certain resources or bands or subchannels only for messages having a certain priority. The gNB 410 may indicate resources in the grant to be used only for high priority transmissions, or transmissions higher than a configured or preconfigured threshold, by different UEs, when ensuring that these resources are unoccupied, so that the high priority transmissions may be successful. In another scenario, this may also depend on the necessity and urgency of the UE to transmit the high priority transmission. In this case, if the transmission is of a high priority, or higher than a configured or preconfigured threshold, then the gNB 410 may recommend a set of resources that might be highly occupied, but at the same time, recommend to perform a longer duration CAP, like a Type 1 LBT.

FIG. 7 further illustrates a UE 400 in accordance with the second aspect of the present invention. As described, UE 400 is performing a sidelink transmission on resources in the unlicensed spectrum and, in accordance with embodiments, in addition to the grant, received from the gNB 410, receives the above-described indication on the availability of the resources included in the grant, for example, the above-described recommendation.

Dependent on the recommendation from the gNB 410, UE 400, as is indicated at 464, performs the sidelink transmission in the unlicensed spectrum in a way as described above. In accordance with other embodiments, in addition or alternatively, the UE 400, as indicated at 466, may initially perform the sidelink transmission without receiving any recommendation or indication from the gNB, however, in case the UE determines that the currently granted resources are not feasible, the UE may request from the gNB 410 a new grant including other resources together with an indication of the availability of the resources included in the new grant.

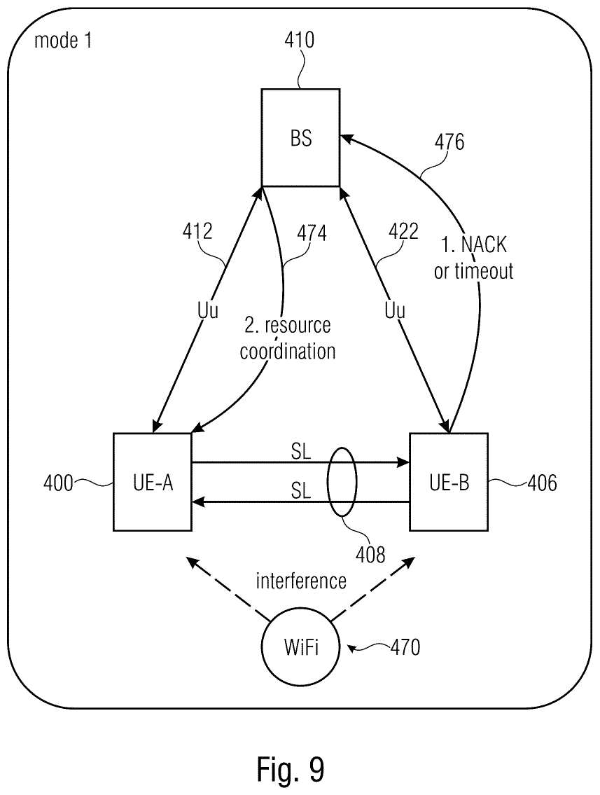

For example, in case UE 400 faces multiple LBT failures for the transmission of a given TB, UE 410 may send a report to the gNB 410 indicating that the currently indicated subband is not feasible, so that the gNB 410 may provide resources in another subband. FIG. 8 illustrates the just-described embodiment, more specifically, a resource coordination by the gNB 410 for UEs operating in Mode 1, i.e., for UEs having a link to the base station 410 via the Uu interface 412, 422. UE-A, like UE 400, performs a transmission on the sidelink 408, which may either be an initial transmission towards UE-B, like UE 406, or a transmission of a feedback responsive to a transmission from UE 406 to UE 400. At 470, schematically, an interference on the resources in the unlicensed spectrum due to a transmission by a Wi-Fi device is illustrated, and it is assumed in FIG. 8 that UE 400, for performing the transmission towards UE 406, performs an LBT on the resources initially granted by base station 410 for the transmission. In case the LBT fails for a certain number of times, like a configured or preconfigured number of LBT failures, UE 400 may send a request, as is indicted at 472, to base station 410 which, in turn, provides, as indicated at 474, a resource coordination, i.e., may provide a new grant including new resources together with an indication of the availability of the resources in the grant which are then used by UE 400 for performing the transmission towards UE 406.

In accordance with other embodiments, the UE 400 may query the base station or roadside unit 410 for a resource recommendation also by sending a request 472. This may be dependent on the UE's measurements or on the above-described success rate when performing a certain NR-U channel access procedure, like the LBT procedures. For example, after a certain number of LBT failures, like a configured or preconfigured number of LBT failures, UE 400 may trigger the resource recommendation request 472 to the gNB 410 via Mode 1 signaling, i.e., over the Uu interface 412. The request, in accordance with embodiments, may also include a condition under which the UE 400 desires to be supported via a licensed service, for example, using Mode 1. In other words, in case the resource pool 420 provided for the SL communications includes resources for both the licensed spectrum 416 and the unlicensed spectrum 418, or the UE 400 is configured or preconfigured by the gNB 410 with separate resource pools in the licensed spectrum 416 and unlicensed spectrum 418, UE 400 may determine that a certain condition exists and that, given this condition applies, it is of advantge to perform the transmission using resources from the licensed spectrum 416. These conditions may include one or more of the following:
a configured or preconfigured LBT failure threshold, above which the condition is triggered,
a transmission with a priority above a configured or preconfigured threshold, e.g., the resources granted span one or more subchannels, with a number of resources blocks, RBs, within the subchannel being dependent on the priority; for example, high priority UEs or UEs with high data rate demand may get grants with larger subchannels, i.e., more frequency resources,
a transmission with an impending PDB, where the remaining PBD is above a configured or preconfigured threshold,
a transmission with a high data payload that may not be transmitted in the resource pool defined in the unlicensed spectrum 418 since its subchannel or sub band size is too small for the data payload,
the sensing results or the CAP results are inconclusive, e.g., if there is a certain uncertainty attached to these results, due to the cases where the sensing results are outdated or not of a certain granularity due to only partial sensing.

Responsive to the request 472, the gNB 410 may reconfigure UE 400 in such a way that UE 400 may decide, based on the condition, when to switch to a licensed carrier instead of an unlicensed carrier. In case the initial grant provided by the gNB 410 does not suit the UE 400 due to the aforementioned conditions, the gNB 410 may provide a resource recommendation 474 or another grant with resources within a resource pool in the licensed spectrum. For example, if the UE 400 attempted the maximum number of LBT failures for a given transmission, or if the transmission is of a higher priority with only a smaller remaining PBD, the UE 400 may send the request 472 to the gNB 410, in response to which the gNB 410 provides the UE 400 with a resource coordination message 474, which is essentially another grant pointing to resources in another resource pool within the licensed spectrum 416.

For example, the conditions that the UE may request the gNB for a switch from the unlicensed to the licensed spectrum may include one or more of:
multiple LBT failures, or LBT failures have hit a maximum (pre-) configured threshold,
high priority transmissions with an impending PDB,
a data quota required by the UE, e.g., if the data is to less in SL-U, may cause a switch to the licensed spectrum, or
an uncertainty, e.g., if the sensing results from the network entity have a certain uncertainty attached, like in case the sensing data is outdated, or in case the sensing results are not of a certain granularity, the SL-UE may not want to transmit in unlicensed spectrum.

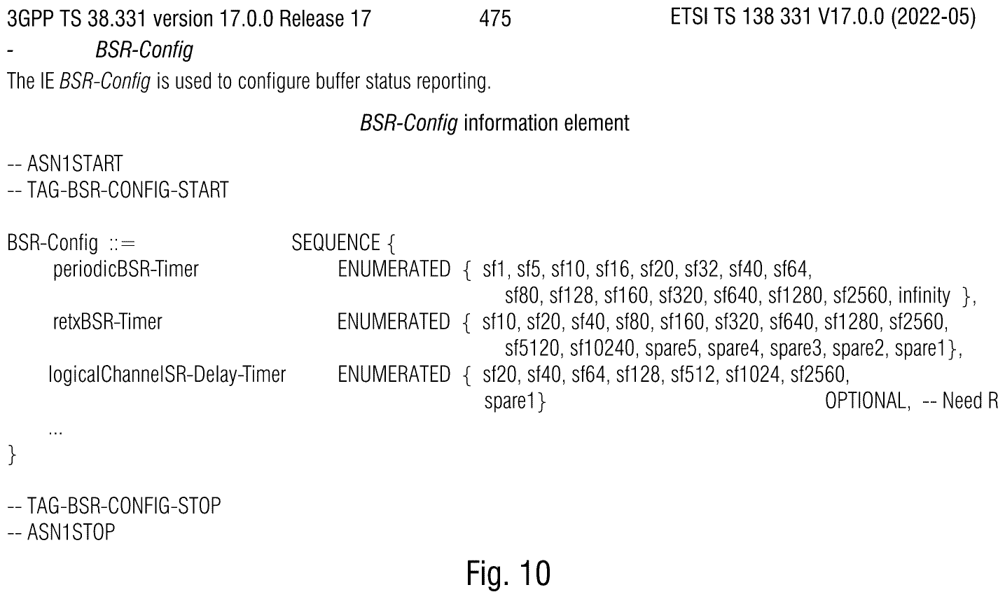

FIG. 9 illustrates a further embodiment concerning the resource configuration performed by the gNB 410. Other than in FIG. 8, which relied on a request-based resource coordination by the base station 410, in accordance with FIG. 9 an embodiment is illustrated in which the resource coordination is feedback-based. In the embodiment of FIG. 9, it is assumed that UE 406 sends a sidelink transmission over the sidelink 408 to the UE 400, which is to reply with the feedback, like an acknowledgement ACK or non-acknowledgement, NACK, back to UE 406. In case UE 406 receives no ACK or experiences a timeout, i.e., in case UE 406 does not receive an acknowledge about the successful reception of the transmission at the UE 400, this is signaled as a NACK or timeout to the base station 410, as is indicated at 476. The base station, responsive to the indication 476 transmits a resource coordination message 474 which provides to UE 400 a new grant with new resources for performing the feedback transmission over the sidelink to the transmitting UE 406. Thus, in the embodiment of FIG. 9, the resource coordination message 474 is triggered by the transmitter UE, like UE 406, which transmits data to UE 400 and does not receive the acknowledgement within a certain period such that a timeout occurs.

In accordance with other embodiments, assuming that the UE 400 transmits data to UE 406 but UE 406 may not reach UE 400 over the sidelink or does not get an access, like an LBT access, to the channel in the unlicensed spectrum for transmitting the acknowledgement of non-acknowledgement, UE 406 signals a HARQ feedback to the gNB 410 which, in case the HARQ feedback indicates a non-acknowledgement, may trigger a resource coordination message 474 to the transmitter UE 400 so that the UE 400 may receive a new grant with new resources for performing the transmission over the sidelink 408. In other words, when UE-A transmits data to UE-B, and when UE-B has to transmit a NACK back to UE-A signaling the non-receipt of the transmission, and if UE-B may not find resources to transmit the said NACK feedback, UE-B may choose to report this feedback to the gNB over the Uu interface using a PUCCH/PUSCH resource. UE-B report the feedback to the gNB only if attempts to access the PSFCH channel are unsuccessful, after reaching a configured or preconfigured number of LBT failures. The gNB, in response to receiving such a report, triggers the transmission of a resource coordination message 474 to UE-A, providing UE-A with a grant with a new set of resources for UE-A to attempt a retransmission. This is because UE-A failed to transmit successfully using the initial grant, and hence based on the feedback provided by UE-B, the gNB provides UE-A with a new set of resources in order to try retransmitting to UE-B.

In accordance with embodiments, UE-A is assisting UE-B and UE-A is requesting the gNB for a grant, which UE-A may then provide to UE-B.

### Signaling Aspects

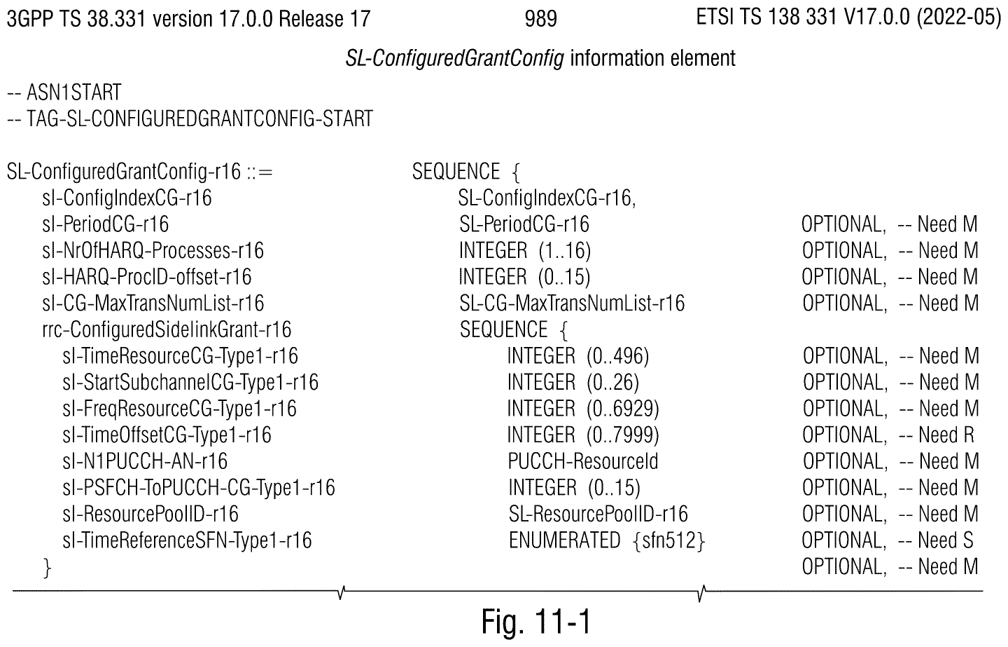

In the following signaling aspects applying to the first and second aspects of the present invention are described. In accordance with embodiments, the signaling from the gNB 410 may include a resource request, like a buffer status report, BSR. FIG. 10 illustrates a conventional BSR-Config Information Element, IE, that, in accordance with embodiments, may be modified by adding that the request is for resources in the unlicensed spectrum, like from an unlicensed resource pool or subband. For example, a parameter spectrumType may be included, which may be either a Boolean flag where 0 indicates licensed and 1 indicated unlicensed spectrum resources, or a enumerated parameter with the values licensed and unlicensed. Further, a channel access priority or a kind of service type may be added that informs that gNB that the resource provided by the gNB 410 is to maintain a certain quality, for example, so as to allow a certain QoS profile to be fulfilled. For example, a parameter channelAccessPriority or Priority or QoSProfile may be included, where the values included may be mapped to the channel access priority class (CAPC) table (see Table 4.2.1-1 from TS 37.213), the PQI priority values or QoS profiles (see Table 5.4.4-1 from TS 23.287). Moreover, a request for a secondary resource set in the unlicensed or licensed spectrum may be indicated, so that, for example, transmissions with a certain property, like a priority above a certain threshold or if the number of LBT failures is above a certain threshold, may use secondary resources in the licensed spectrum as a fallback solution for performing the transmission, in case the primary resources in the unlicensed spectrum turn out to be not feasible for performing the transmission with a desired property. For example, two parameters may be included, with the first parameter being secondaryBand, which is a Boolean flag where 0 indicates that the secondary spectrum is not supported and 1 indicates that it is supported. The second parameter may be spectrumTypeSecondary, which may be either a Boolean flag where 0 indicates licensed and 1 indicated unlicensed spectrum resources, or a enumerated parameter with the values licensed and unlicensed.

In accordance with further embodiments, the UE 400 may signal to the gNB a feedback report that may include a CAP failure statistic, i.e., a statistic about how often a channel access procedure, like an LBT procedure, failed. For example, a number of failures or a percentage of failures may be indicated or a flag may be signaled indicating that a certain failure threshold was exceeded. In accordance with further embodiments, also a measurement report, like a resource occupancy report, e.g., a zonal area resource usage map, ZARUM (see e.g., WO 2019/096705 A1), of geographical zones served by the gNB, or a RSSI report, or a RSRP report, or a SNR report, or a SINR report, regarding the unlicensed resources or any other type of channel state information, CSI, may be provided by the UE. In accordance with yet other embodiments, also a CG status may be indicated as a feedback, for example, to indicate whether the UE was able to successfully or unsuccessfully use the resources provided by the gNB. Since the CG is essentially a set of resources within a resource pool, it is helpful for the gNB to understand whether the UE was able to use these resources or not. This is especially useful if the gNB has no other means to understand the resource usage status by other non-3GPP UEs. If the UE reports that it was not able to use these resources, the gNB may make sure that it does not provide these resources to other UEs since they may be occupied by other non-3GPP UEs. If it received a positive feedback on the usage of these resources, then the gNB may continue to provide the grant with these resources to other UEs as well, with the confidence that they are not occupied by other non-3GPP UEs.

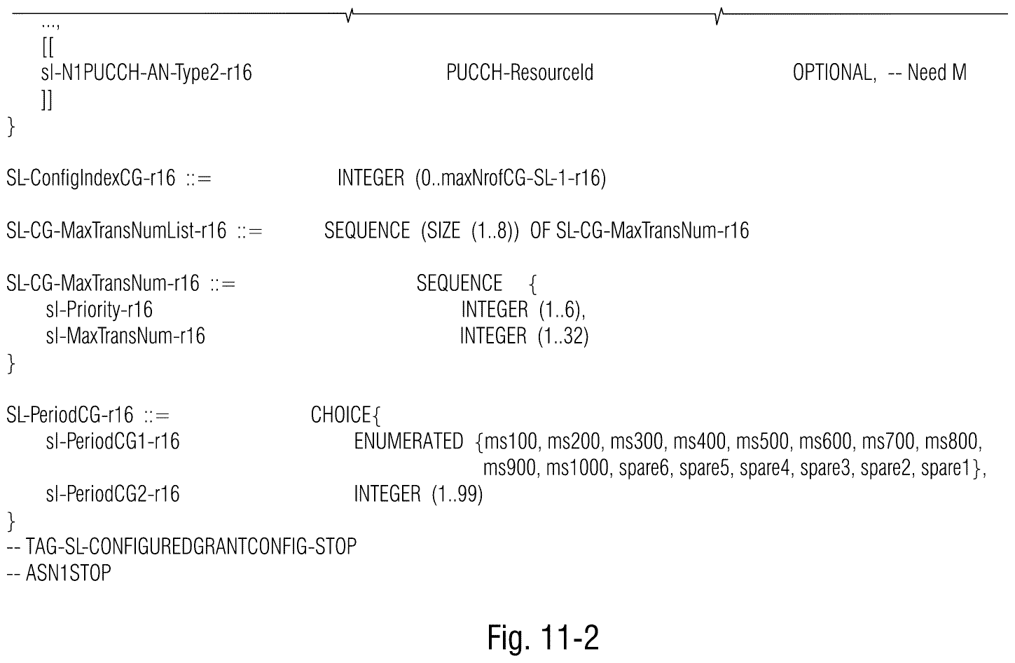

Regarding a signaling from the gNB 410 to the UE 400, FIG. 11 illustrates a conventional SL-ConfiguredGrantConfig IE that, in accordance with embodiments, may be modified to include one or more of the following:
an LBT type to be used by the UE,
a channel access priority, for example, that the UE is configured to transmit traffic of a certain priority in the unlicensed band,
a conditional threshold when to switch to a licensed carrier, for example in case of successive LBT failures,
a conditional threshold when to switch to an unlicensed carrier, for example, in case the UE is bound to still operate in a licensed spectrum for a certain time period,
resources in one or more further secondary licensed or unlicensed bands in case the above-mentioned conditional thresholds occur, for example a set of resources in the licensed band if a configured or preconfigured number of LBT failures took place.

In accordance with further embodiments, the wireless communication network provides a plurality of SL-U RPs having different numerologies, and the network entity grants the resource from a SL-U RP having a certain numerology, the certain numerology depending on a characteristic of the SL transmission. For example, UEs with a URLLC demand, get subchannels within a BWP with higher subcarrier spacing (SCS).

### General

Embodiments of the present invention have been described in detail above, and the respective embodiments and aspects may be implemented individually or two or more of the embodiments or aspects may be implemented in combination.

It is noted that the inventive approach is not limited to CGs or DGs. In accordance with other embodiments, a grant may be less than a CG or DG, or it may just be a broad kind of resource coordination, e.g., which subband or subchannel to use or to avoid.

In accordance with embodiments, the wireless communication system may include a terrestrial network, or a non-terrestrial network, or networks or segments of networks using as a receiver an airborne vehicle or a space-borne vehicle, or a combination thereof.

In accordance with embodiments of the present invention, a user device comprises one or more of the following: a power-limited UE, or a hand-held UE, like a UE used by a pedestrian, and referred to as a Vulnerable Road User, VRU, or a Pedestrian UE, P-UE, or an on-body or hand-held UE used by public safety personnel and first responders, and referred to as Public safety UE, PS-UE, or an IoT UE, e.g., a sensor, an actuator or a UE provided in a campus network to carry out repetitive tasks and requiring input from a gateway node at periodic intervals, a mobile terminal, or a stationary terminal, or a cellular IoT-UE, or a vehicular UE, or a vehicular group leader (GL) UE, or a sidelink relay, or an IoT or narrowband IoT, NB-IoT, device, or wearable device, like a smartwatch, or a fitness tracker, or smart glasses, or a ground based vehicle, or an aerial vehicle, or a drone, or a moving base station, or road side unit (RSU), or a building, or any other item or device provided with network connectivity enabling the item/device to communicate using the wireless communication network, e.g., a sensor or actuator, or any other item or device provided with network connectivity enabling the item/device to communicate using a sidelink the wireless communication network, e.g., a sensor or actuator, or any sidelink capable network entity.

In accordance with embodiments of the present invention, a network entity comprises one or more of the following: a macro cell base station, or a small cell base station, or a central unit of a base station, an integrated access and backhaul, IAB, node, or a distributed unit of a base station, or a road side unit (RSU), or a remote radio head, or an AMF, or an MME, or an SMF, or a core network entity, or mobile edge computing (MEC) entity, or a network slice as in the NR or 5G core context, or any transmission/reception point, TRP, enabling an item or a device to communicate using the wireless communication network, the item or device being provided with network connectivity to communicate using the wireless communication network.

Although some aspects of the described concept have been described in the context of an apparatus, it is clear that these aspects also represent a description of the corresponding method, where a block or a device corresponds to a method step or a feature of a method step. Analogously, aspects described in the context of a method step also represent a description of a corresponding block or item or feature of a corresponding apparatus.

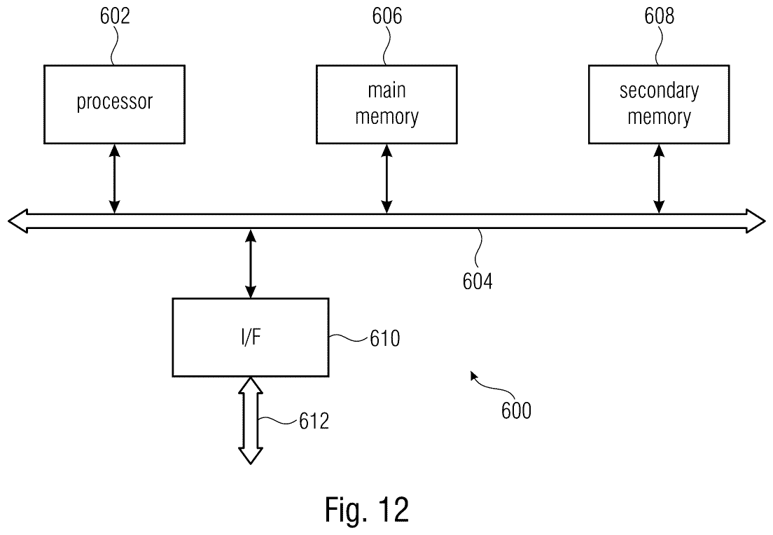

Various elements and features of the present invention may be implemented in hardware using analog and/or digital circuits, in software, through the execution of instructions by one or more general purpose or special-purpose processors, or as a combination of hardware and software. For example, embodiments of the present invention may be implemented in the environment of a computer system or another processing system. FIG. 12 illustrates an example of a computer system 600. The units or modules as well as the steps of the methods performed by these units may execute on one or more computer systems 600. The computer system 600 includes one or more processors 602, like a special purpose or a general-purpose digital signal processor. The processor 602 is connected to a communication infrastructure 604, like a bus or a network. The computer system 600 includes a main memory 606, e.g., a random-access memory, RAM, and a secondary memory 608, e.g., a hard disk drive and/or a removable storage drive. The secondary memory 608 may allow computer programs or other instructions to be loaded into the computer system 600. The computer system 600 may further include a communications interface 610 to allow software and data to be transferred between computer system 600 and external devices. The communication may be in the from electronic, electromagnetic, optical, or other signals capable of being handled by a communications interface. The communication may use a wire or a cable, fiber optics, a phone line, a cellular phone link, an RF link and other communications channels 612.

The terms “computer program medium” and “computer readable medium” are used to generally refer to tangible storage media such as removable storage units or a hard disk installed in a hard disk drive. These computer program products are means for providing software to the computer system 600. The computer programs, also referred to as computer control logic, are stored in main memory 606 and/or secondary memory 608. Computer programs may also be received via the communications interface 610. The computer program, when executed, enables the computer system 600 to implement the present invention. In particular, the computer program, when executed, enables processor 602 to implement the processes of the present invention, such as any of the methods described herein. Accordingly, such a computer program may represent a controller of the computer system 600. Where the disclosure is implemented using software, the software may be stored in a computer program product and loaded into computer system 600 using a removable storage drive, an interface, like communications interface 610.

The implementation in hardware or in software may be performed using a digital storage medium, for example cloud storage, a floppy disk, a DVD, a Blue-Ray, a CD, a ROM, a PROM, an EPROM, an EEPROM or a FLASH memory, having electronically readable control signals stored thereon, which cooperate or are capable of cooperating with a programmable computer system such that the respective method is performed. Therefore, the digital storage medium may be computer readable.

Some embodiments according to the invention comprise a data carrier having electronically readable control signals, which are capable of cooperating with a programmable computer system, such that one of the methods described herein is performed.

Generally, embodiments of the present invention may be implemented as a computer program product with a program code, the program code being operative for performing one of the methods when the computer program product runs on a computer. The program code may for example be stored on a machine readable carrier.

Other embodiments comprise the computer program for performing one of the methods described herein, stored on a machine readable carrier. In other words, an embodiment of the inventive method is, therefore, a computer program having a program code for performing one of the methods described herein, when the computer program runs on a computer.

A further embodiment of the inventive methods is, therefore, a data carrier or a digital storage medium, or a computer-readable medium comprising, recorded thereon, the computer program for performing one of the methods described herein. A further embodiment of the inventive method is, therefore, a data stream or a sequence of signals representing the computer program for performing one of the methods described herein. The data stream or the sequence of signals may for example be configured to be transferred via a data communication connection, for example via the Internet. A further embodiment comprises a processing means, for example a computer, or a programmable logic device, configured to or adapted to perform one of the methods described herein. A further embodiment comprises a computer having installed thereon the computer program for performing one of the methods described herein.

In some embodiments, a programmable logic device, for example a field programmable gate array, may be used to perform some or all of the functionalities of the methods described herein. In some embodiments, a field programmable gate array may cooperate with a microprocessor in order to perform one of the methods described herein. Generally, the methods may be performed by any hardware apparatus.

While this invention has been described in terms of several embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations and equivalents as fall within the true spirit and scope of the present invention.

1. A network entity for a wireless communication network, like a 3^{rd} Generation Partnership Project, 3GPP, network,
wherein the network entity is to serve a plurality of user devices, which are to communicate with each other over a sidelink, SL, using resources from an unlicensed SL resource pool, SL-U RP, the SL-U RP comprising a plurality of resources from an unlicensed spectrum to be used for SL transmissions,
wherein, for performing a SL transmission on the resources in the unlicensed spectrum by a UE, the network entity is to provide a grant to the UE.

2. The network entity of claim 1, wherein, the grant indicates one or more of the following:
resources from the SL-U RP to be used by the UE for performing the SL transmission in the unlicensed spectrum,
resources from the SL-U RP not to be used by the UE for performing the SL transmission in the unlicensed spectrum.

3. The network entity of claim 1, wherein the network entity is to instruct the UEs to perform a channel access procedure, CAP, or a certain type of CAP, or not to perform the CAP only on the resources of the group to which the UE belongs to.

4. The network entity of claim 1, wherein the network entity is to perform one or more of the following measurements to ensure the availability or unavailability of resources included in the grant:
a measurement of a Reference Signal Receive Power, RSRP, to check whether the resources are occupied by other UEs using the same Radio Access Technology, RAT, as the wireless communication network to which the network entity belongs,
a measurement of a Received Signal Strength Indication, RSSI, or a Signal to Noise Ratio, SNR, or a Signal to Noise Interference Ratio, SINR to check whether the resources are occupied UEs using a RAT different from the RAT used by the wireless communication network to which the network entity belongs,
a decoding of control messages transmitted on the resource, e.g., 3GPP downlink control information, DCI, or 3GPP sidelink control information, SCI, or an IEEE 802. 11 Physical Layer Convergence Protocol, PLCP, header, or an extraction of information on one or more transmissions, like ongoing or upcoming transmissions or a remaining duration of an ongoing transmission,
a decoding of assistance information, AIM.

5. The network entity of claim 4, wherein the network entity, on performing measurements on resources, comprises resources in the grant only if the resources are ascertained to be available, depending on whether the resulting measurement is equal to or below a defined or predefined threshold.

6. The network entity of claim 4, wherein the network entity, on performing measurements on resources, comprises resources in the grant only if the resources are ascertained to be unavailable, depending on whether the resulting measurement is above a defined or predefined threshold.

7. The network entity of claim 4, wherein the network entity is to provide the resources included in the grant responsive to
a resource request or a SL buffer status report, BSR, from the UE, or
a request from the UE requesting the network entity to provide a new grant comprising other resources, or
a request from the UE to perform a retransmission, or
a collision indication from the UE, or
a request from a UE assisting another UE, e.g., a UE providing a preferred and/or non-preferred set of resource to another UE via an inter-UE coordination information, IUC, message or via an assistance information message, AIM.

8. The network entity of claim 4, wherein the network entity is to identify the availability of the resources to be included in the grant based on
sensing the resources in the SL-U RP, and/or
assistance information messages received at the network entity which indicate for the resources in the SL-U RP an occupancy status, and/or
assistance information received from a different network entity or from a core network, CN, entity, e.g., a network function, NF, such as a spectrum database, and/or
a non-3GPP sensing device, e.g., a WiFi access point integrated in the network entity or comprising an interface to the network entity.

9. The network entity of claim 1, wherein a CAP, which the UE is expected to perform, comprises one or more to the following:
a Listen-Before-Talk, LBT, procedure on the resource,
a detection of one or more energy levels on the resource, e.g., a Received Signal Strength Indication, RSSI, a Signal to Noise Ratio, SNR, or a Signal to Noise Interference Ratio, SINR,
a measurement of pilot symbols transmitted on the resource and/or determination of one or more measured values, e.g., a 3GPP Reference Signal Receive Power, RSRP, or a 3GPP Reference Signal Received Quality, RSRQ,
a decoding of a sidelink assistance information message, AIM,
a decoding of control messages transmitted on the resource, e.g., 3GPP sidelink control information, SCI, or an IEEE 802.11 Physical Layer Convergence Protocol, PLCP, header, and an extraction of information on one or more transmissions, like ongoing or upcoming transmissions or a remaining duration of an ongoing transmission.

10. The network entity of claim 9, wherein the LBT, procedure comprises:
a type-1 CAP that senses the resource for the SL transmission for a random time duration, or
a type-2A CAP that senses the resource for the SL transmission for 25 μs, or
a type-2B CAP that senses the resource for the SL transmission for 16 μs,
a type-2C CAP that does not sense the resource for the SL transmission, or
a new type of CAP that senses a channel for the SL transmission with a configured or preconfigured time duration.

11. The network entity of claim 9, wherein the CAP evaluates, based on sensing, an availability of a channel for performing the SL transmissions, wherein a certain duration of the channel is considered to be idle when the channel is sensed during the certain duration and when it is determined that a detected power for at least a certain time within the certain duration is less than an energy detection threshold, otherwise, the certain channel is considered to be busy.

12. A user device, UE, for a wireless communication network, like a 3^{rd} Generation Partnership Project, 3GPP, network,
wherein the UE is served by a network entity and is to communicate with other UEs over a sidelink, SL, using resources from an unlicensed SL resource pool, SL-U RP, the SL-U RP comprising a plurality of resources from an unlicensed spectrum to be used for SL transmissions,
wherein, for performing a SL transmission on the resources in the unlicensed spectrum, the UE is to receive from the network entity a grant, the grant indicating the resources from the SL-U RP to be used by the UE for performing the SL transmission in the unlicensed spectrum.

13. The user device, UE, of claim 12, wherein, the grant indicates one or more of the following:
resources from the SL-U RP to be used by the UE for performing the SL transmission in the unlicensed spectrum,
resources from the SL-U RP not to be used by the UE for performing the SL transmission in the unlicensed spectrum.

14. The user device, UE, of claim 12, wherein the UE is instructed to perform a channel access procedure, CAP, or a certain type of CAP, or not to perform the CAP only on the resources of the group to which the UE belongs to.

15. The user device, UE, of claim 12, wherein a CAP, which the UE is expected to perform, comprises one or more to the following:
a Listen-Before-Talk, LBT, procedure on the resource,
a detection of one or more energy levels on the resource, e.g., a Received Signal Strength Indication, RSSI, a Signal to Noise Ratio, SNR, or a Signal to Noise Interference Ratio, SINR,
a measurement of pilot symbols transmitted on the resource and/or determination of one or more measured values, e.g., a 3GPP Reference Signal Receive Power, RSRP, or a 3GPP Reference Signal Received Quality, RSRQ,
a decoding of a sidelink assistance information message, AIM,
a decoding of control messages transmitted on the resource, e.g., 3GPP sidelink control information, SCI, or an IEEE 802.11 Physical Layer Convergence Protocol, PLCP, header, and an extraction of information on one or more transmissions, like ongoing or upcoming transmissions or a remaining duration of an ongoing transmission.

16. The user device, UE, of claim 15, wherein the LBT, procedure comprises:
a type-1 CAP that senses the resource for the SL transmission for a random time duration, or
a type-2A CAP that senses the resource for the SL transmission for 25 μs, or
a type-2B CAP that senses the resource for the SL transmission for 16 μs,
a type-2C CAP that does not sense the resource for the SL transmission, or
a new type of CAP that senses a channel for the SL transmission with a configured or preconfigured time duration.

17. The user device, UE, of claim 14, wherein the CAP evaluates, based on sensing, an availability of a channel for performing the SL transmissions, wherein a certain duration of the channel is considered to be idle when the channel is sensed during the certain duration and when it is determined that a detected power for at least a certain time within the certain duration is less than an energy detection threshold, otherwise, the certain channel is considered to be busy.

18. The user device, UE, of claim 14, wherein the UE is to request from network entity to provide the grant, dependent on one or more of the following:
a resource request or a SL buffer status report, BSR, or
a collision indication, or
a request to assist another UE, e.g., the UE intending to provide a preferred and/or non-preferred set of resource to another UE via an inter-UE coordination information, IUC, message or via an assistance information message, AIM,
a determined occupancy status of the resources currently granted,
a number of failed CAPs/LBTs on the currently granted resources,
in case the UE is a transmitting UE and does not receive an acknowledgement from a receiving UE within a certain period, wherein the request is a request to the network entity to provide the new grant to the receiving UE.

19. The user device, UE, of claim 18, wherein the request for the new grant comprises a certain condition under which the UE is to be supported using resources from a licensed spectrum, and wherein the UE is to receive from the network entity a configuration enabling the UE to switch, based on the condition, to resources from the licensed spectrum.

20. A method for operating a user device, UE, for a wireless communication network, like a 3^{rd} Generation Partnership Project, 3GPP, network, wherein the UE is served by a network entity and is to communicate with other UEs over a sidelink, SL, using resources from an unlicensed SL resource pool, SL-U RP, the SL-U RP comprising a plurality of resources from an unlicensed spectrum to be used for SL transmissions, the method comprising:
receiving from the network entity a grant for performing a SL transmission on the resources in the unlicensed spectrum, the grant indicating the resources from the SL-U RP to be used by the UE for performing the SL transmission in the unlicensed spectrum.
